(19) United States
(12) Patent Application Publication
(10) Pub. No.: US 2017/0061490 A1
(43) Pub. Date: Mar. 2, 2017

(54) BEACON-FACILIATED CONTENT MANAGEMENT AND DELIVERY

(71) Applicant: Candy Lab, Inc., Irvine, CA (US)

(72) Inventors: Kourosh Ghahremani, Irvine, CA (US); Gilda C. Campos, Irvine, CA (US); Andrew W. Couch, Irvine, CA (US)

(21) Appl. No.: 15/249,317

(22) Filed: Aug. 26, 2016

Related U.S. Application Data
(60) Provisional application No. 62/210,835, filed on Aug. 27, 2015.

(51) Int. Cl. G06Q 30/02; H04W 4/18; H04W 48/10; H04W 4/02

(52) U.S. Cl. CPC G06Q 30/0261; H04W 4/023; H04W 4/185; H04W 48/10; G06Q 30/0277; H04W 88/02

(57) ABSTRACT

A platform for facilitating hyper-local advertising utilizing mobile computing devices and beacons emitting signals to mobile computing devices. Receiving at a mobile computing device a signal from a beacon, the signal including identification information for the beacon. Determining a distance between the beacon and the mobile computing device. Displaying in a graphical user interface of a mobile computing device a virtual item associated with the beacon. Varying the size of the virtual item displayed on the screen based on the distance between the beacon and the mobile computing device. Receiving a user-generated input through the mobile computing device activating the virtual item displayed on the screen of the mobile computing device. Providing a visualization on the screen of the mobile computing device in a graphical user interface, the visualization associated with the beacon.

### CROSS-REFERENCE TO RELATED APPLICATIONS

This application claims priority to and the benefit of U.S. Provisional Patent Application No. 62/210,835 filed on Aug. 27, 2015 and entitled “Beacon-Facilitated Content Management and Delivery,” the subject matter of which is incorporated herein in its entirety for all purposes.

### TECHNICAL FIELD

The subject matter described herein relates systems, methods, and articles that enable location-based delivery of content.

### BACKGROUND

The use of mobile computing devices, such as smartphones, is becoming ubiquitous. Marketers and advertisers are developing ways to utilize mobile computing devices in their efforts to provide incentives to consumers. Typical mobile computing devices include hardware and software components that can facilitate determination of the location of the mobile computing devices relative to a fixed point. The combination of determining the location of a mobile computing device and the desire to provide incentives to consumers has lead to the advent of location-based services.

Mobile computing devices also typically include cameras. These mobile computing devices are increasingly enabling users/developers to use cameras for applications other than photographs and video. Image feeds from cameras can be augmented with the determination of the location of the mobile computing device. The augmentation can be performed by applications executing on the mobile computing device.

### SUMMARY

The current subject matter may provide systems, methods, and articles relating to facilitating the provision of graphical content by vendors to mobile computing devices based on the location of the mobile computing devices. The current subject may also provide ways for vendors to provide real-world incentives to users of mobile computing devices based on the location of the mobile computing devices.

In one aspect, a method and apparatus is provided. The method can be executed by at least one data processor of a mobile computing device. The method can include receiving at a mobile computing device a signal transmitted by a beacon. The signal can indicate an identity of the beacon. A distance can be determined, by the mobile computing device, between the beacon and the mobile computing device. A virtual item associated with the beacon can be displayed in a graphical user interface of the mobile computing device. The size of the virtual item displayed in the graphical user interface can be varied based on the determined distance.

In some variations one or more of the following features can optionally be included in any feasible combination. A user-generated input can be received through the mobile computing device activating the virtual item displayed on the screen of the mobile computing device. A visualization can be presented on the screen of the mobile computing device in a graphical user interface in response to the user interaction. The visualization can be associated with the beacon. The visualization can include a game, multimedia content, social media content, an advertisement, an offer, video content, graphical content, and/or informational content. The visualization can be configured to facilitate the collection of virtual points by a user of the mobile computing device. The virtual points can be redeemable for value from a vendor associated with the beacon.

The signal transmitted by the beacon can be transmitted continuously or intermittently. The signal transmitted by the beacon can include a time at which the signal was transmitted by the beacon.

The beacon can be associated with a product. The virtual item associated with the beacon can resemble the product.

A notification can be displayed on a screen of the mobile computing device indicating that a signal transmitted by a beacon has been received at the mobile computing device. A notification can be displayed on a screen of a remote computing device electronically connected to the mobile computing device, indicating that a signal transmitted by a beacon has been received at the mobile computing device.

The distance between the beacon and the mobile computing device can based on a strength of the signal, transmitted by the beacon, as received at the mobile computing device. The distance can be based on a time at which the signal is received at the mobile computing device.

The method can further comprise receiving, at the mobile computing device, in response to receiving the signal transmitted by the beacon, the virtual item associated with the beacon from a web server. A request can be transmitted by the mobile computing device for the virtual item associated with the beacon through the one or more web servers. The virtual item associated with the beacon can be maintained by a platform server.

The method can further comprise receiving at the mobile computing device a second signal transmitted by a second beacon. The second signal can indicate an identification information identity of the beacon. A distance between the second beacon and the mobile computing device can be determined. A second virtual item associated with the second beacon can be displayed in the graphical user interface of the mobile computing device concomitantly with the virtual item associated with the beacon. The size of the second virtual item displayed in the graphical user interface can be varied based on the determined distance between the second beacon and the mobile computing device.

The mobile computing device can comprise a camera. The graphical user interface of the mobile computing device can display a field of view captured by the camera. The virtual item associated with the beacon can overlay the field of view captured by the camera and presented in the graphical user interface.

The method can further comprise receiving, at the mobile computing device, a geo-location signal. A geo-location of the mobile computing device can be determined based on the geo-location signal. A virtual item associated with the geo-location of the mobile computing device can be received at the mobile computing device. The virtual item can be presented in a graphical user interface on a screen of the mobile computing device.

In another aspect a method and apparatus can be provided where processes are performed by a platform server. The identity of a beacon configured to transmit a signal indicating an identity of the beacon can be received at a platform server. Virtual content can be received at the platform server. The virtual content can be configured for presentation in a graphical user interface of a screen of a mobile computing device. The mobile computing device can be configured to receive the signal transmitted by the beacon. An indication that the mobile computing device has received the signal from the beacon can be received at the platform server. The virtual content associated with the beacon can be transmitted to the mobile computing device for presentation in a graphical user interface on a screen of the mobile computing device.

In some variations one or more of the following features can optionally be included in any feasible combination. An indication that the virtual content presented in a graphical user interface of the mobile computing device has been interacted with by a user can be received by the platform server. Additional virtual content associated with the beacon can be transmitted by the platform server to the mobile computing device. The additional virtual content can be configured for presentation in the graphical user interface on the screen of the mobile computing device.

Contact information associated with the mobile computing device can be received at the platform server. The contact information can a MAC address of the mobile computing device, an IP address of the mobile computing device, an email address of a user of the mobile computing device, and/or a telephone number of a user of the mobile computing device. The contact information can be transmitted by the platform server, to an operator of the beacon.

The beacon can be located with a product. The virtual content can be associated with the beacon is associated with the product. An offer can be presented to the user of the mobile computing device.

Computer program products are also described that comprise non-transitory computer readable media storing instructions, which when executed by data processors of computing systems, causes at least one data processor to perform operations herein. Similarly, computer systems are also described that may include processors and a memory coupled to the data processors. The memory may temporarily or permanently store instructions that cause at least one processor to perform the operations described herein. In addition, methods can be implemented by data processors either within a single computing system or distributed among two or more computing systems. Such computing systems can be connected and can exchange data and/or commands or other instructions or the like via connections, including but not limited to a connection over a network (e.g. the Internet, a wireless wide area network, a local area network, a wide area network, a wired network, or the like), via a direct connection between the multiple computing systems, etc.

The details of variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating mobile computing devices interacting with beacons, web servers and at least one platform server in accordance with some embodiments;

FIG. 2A-2F is an illustration of a web-based platform in accordance with some embodiments;

FIG. 3 is an illustration of an environment having beacons in accordance with some embodiments;

FIGS. 4A-4E illustrate screenshots showing visualizations associated with beacons, in accordance with some embodiments;

FIG. 5 is a process flow diagram illustrating a method of providing content to a mobile computing device in accordance with some embodiments;

FIG. 6A-6F illustrate screenshots showing visualizations of media content presented on screens of mobile computing devices in accordance with some embodiments;

FIG. 7A-7D illustrate screenshots of graphical user interfaces associated with providing notifications on mobile computing devices in accordance with some embodiments;

FIG. 8 is an illustration of a graphical user interface presented on the screen of a mobile computing device in accordance with some embodiments;

FIG. 9 is an illustration of a screenshot providing a visualization of a loading screen for a mobile application in accordance with some embodiments;

FIGS. 10A-10D are illustrations showing screenshots of visualizations of a mobile application in accordance with some embodiments;

FIG. 11 is a process flow diagram illustrating a method for initiating a beacon in accordance with some embodiments; and,

FIG. 12 is an illustration of a sample dataflow for presenting content on a mobile computing device in accordance with some embodiments.

### DETAILED DESCRIPTION

The current subject matter describes systems, methods, and articles relating to facilitating the provision of graphical content by vendors to mobile computing devices based on the location of the mobile computing devices. The location of the mobile computing devices can be based on the proximity of mobile computing devices to beacons. Signals from the beacons can be received at mobile computing devices to facilitate determination of the location of mobile computing devices relative to the beacons. A graphical user interface can be provided on a screen of the mobile computing device to facilitate presentation of an indication of the proximity of the mobile computing device to one or more beacons. Individual beacons can be associated with an icon presented through the graphical user interface. The size of the icon presented to the user of the mobile computing device can be varied to change in size based on the distance of the mobile computing device to the beacon.

For example, a mobile computing device can execute a mobile application that causes presentation of visualizations of beacons in a graphical user interface of the mobile computing device. The visualizations of the beacons can be in the form of icons. The icons can resemble real-world objects or can be abstract illustrations. When the mobile computing device comes within range of a beacon, the visualization, or icon, associated with the beacon can be presented in the graphical user interface. As the mobile computing device is moved toward the beacon, the size of the icon for that beacon can be increased. When the mobile computing device is moved away from the beacon, the size of the icon for that beacon can be decreased.

In another example, a beacon can be located in a men's shoe department of a department store. A mobile computing device implementing a mobile application configured to facilitate visualization of the beacon in a graphical user interface on a screen of the mobile computing device can come into range of the beacon in the men's shoe department. An icon associated with that beacon can be presented in the graphical user interface. In this example, the icon can be a graphical representation of a man's shoe. When the mobile computing device is moved toward the men's shoe department, and in particular, toward the location of the beacon, the size of men's show icon can be increased.

A user of the mobile computing device can interact with the icon. For example, through a touch screen of the mobile computing device. In response to a user's interaction with the icon, additional virtual content can be presented in the graphical user interface. The additional virtual content can include promotions, advertisement, tokens, games, information and the like.

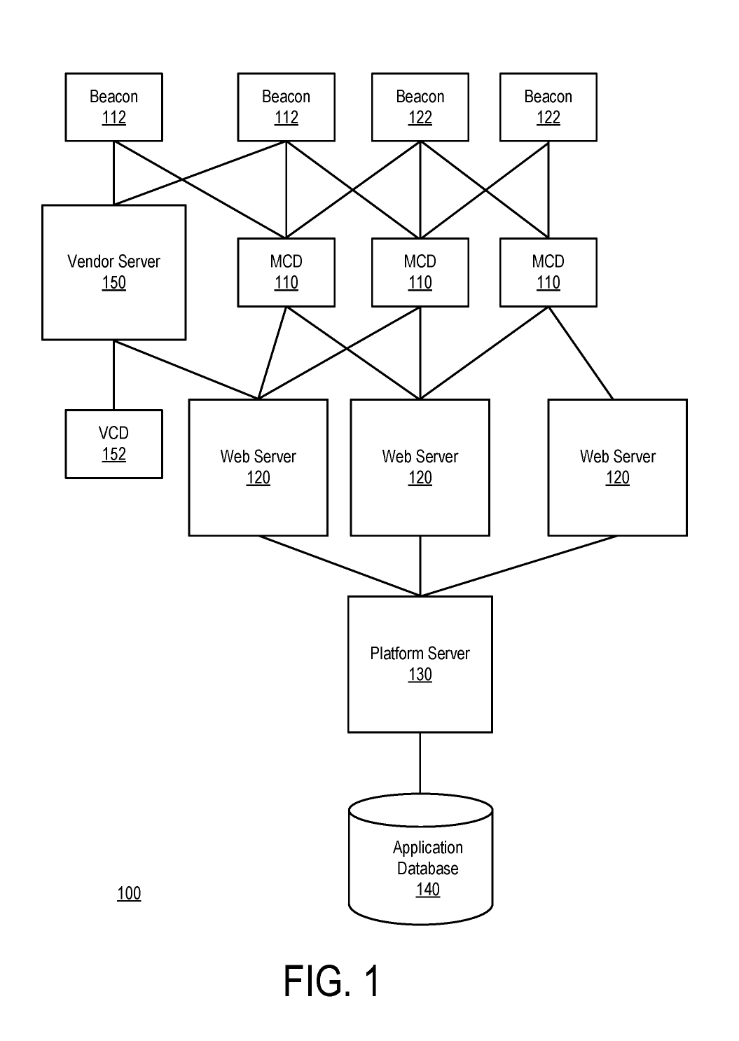

FIG. 1 is a diagram 100 illustrating a system having a plurality of mobile computing devices 110. It will be appreciated that one or more of the elements illustrated in FIG. 1 can be omitted or combined depending on the desired implementation. The mobile computing device 110 can comprise a mobile phone, a table computer, an eyewear based system (such as GOOGLE GLASS), a watch having a camera, or other mobile systems having cameras, or alternatively a transparent aspect and the ability to communicate with a network such as the Internet, cellular network, public land mobile network, WiFi, and the like.

The mobile computing devices 110 can be coupled to at least one web server 120. The mobile computing devices 110 can be coupled to the at least one web server 120 through a network, for example, the Internet. The mobile computing devices 110 can be configured to communicate with the at least one web server 120 using a wireless communication standard. In some variations, the mobile computing devices 110 can communicate using wireless wide area network standards. Examples of wireless wide area network standards include EDGE, GPRS, LTE, W-CDMA, UMTS-TDD, and/or other wireless wide area network standards. The mobile computing devices 110 can communicate using wireless local area network standards. Examples of wireless local area networks include Wi-Fi and/or other wireless local area network standards. The mobile computing devices 110 can communicate using wireless personal area network standards. Examples of wireless personal area network standards include Bluetooth, Bluetooth Low Energy, Wireless USB, USB, NFC, ANI, 61oWPAN, ZigBee, Thread and/or other wireless personal area network standards.

The system 100 can have a plurality of beacons 112. The beacons 112 can be configured to emit signals associated with the beacons 112. The signals emitted by the beacons 112 can be radio frequency signals. In some variations, beacons 112 can be configured to emit radio frequency signals using wireless local area networks, wireless personal area network standards, or other wireless technology. Beacons 112 can be associated with a unique identifier. Beacons operating in a standardized framework can be associated with a universally unique identifier. Only one beacon operating within the standardized framework may have any one universally unique identifier. The beacons 112 can be configured to carry or indicate their universally unique identifiers in the signals they emit.

Beacons 112 can be configured to broadcast signals continuously or intermittently. Whether a beacon 112 emits signals continuously or intermittently can depend on the application for which the beacon is being used. In some use cases, the intended receiving device for the emitted signal from the beacon 112 is likely to spend a prolonged period of time within the range of the emitted signal. In such applications having an intermittently emitted signal may be sufficient to facilitate determination of the location of the mobile computing device relative to the beacon 112. Intermittent signal emission can have the advantage of reducing the energy requirements of the beacon 112 providing increased battery life when powered by a battery.

Mobile computing devices 110 can be configured to receive the signals emitted by the beacons 112. When a mobile computing device 110 is within range of a beacon 112, the mobile computing device 110 can be configured to receive the signal emitted by the beacon 112. The mobile computing device 110 can be configured to detect a strength of the signal emitted by the beacon 112. In some variations, the beacon 112 can be configured to comply with a standardized framework wherein all beacons in the framework emit a signal at the same or similar level of power, a known level of power, or a configurable level of power. The mobile computing device 110 can be configured to determine a distance from a beacon 112 based on the strength of the signal as received by the mobile computing device 110 and the known strength of the signal as emitted by the beacon 112. For example, the signal strength measures at a receiver can be used to estimate distance. In some variations, signal strength information associated with the beacon 112 can be provided in the signal emitted by the beacon112. In some variations, the mobile computing device 110 can cross-reference the unique identifier of the beacon 112 with online resources to obtain signal strength information associated with the beacon 112. For example, a first beacon can emit a signal having a stronger signal strength than a second beacon. The mobile computing device 110, through web servers 120, can obtain the emitted signal strength for each of the beacons. The mobile computing device 110 can determine the distance between itself and each of the beacons based on the known emitted signal strength of each beacon and the strength of the signal from each beacon as received by the mobile computing device.

The beacon 112 can be configured to include a timestamp in the emitted signal. The timestamp can be calibrated such that the timestamp is based on a standardized or common time base such as GPS time, a common network time, or the like. The mobile computing device 110 can be similarly calibrated. The mobile computing device 110 can be configured to determine the distance to the beacon 112 based on the receipt time of the emitted signal and a known velocity of the emitted signal.

The mobile computing devices 110 can be configured to execute a client application. The client applications can be computer software products configured to facilitate presentation of virtual content to users of the mobile computing devices 110 through screens associated with the mobile computing devices 110. Virtual content can include any content capable of being presented on a screen of the mobile computing device. For example, virtual content can include graphical representations of beacons, offers, advertisements, online games, multimedia content, and/or other virtual content.

Virtual content associated with individual beacons 112 can be presented to a user through a user interface on a screen of a mobile computing device 110. The virtual content can be accessed by a mobile computing device 110 through a web server 120. In some variations, the virtual content can be stored by the mobile computing device 110 and presented to the user in response to the mobile computing device 110 coming within a predefined threshold distance of the beacon 112.

The web server(s) 120 can be coupled to at least one platform server 130. The platform server 130 can be configured to support the operations of one of more applications executed by the mobile computing devices 110. Data can be transmitted between the mobile computing devices 110 and the platform server 130 through the web server(s) 120.

In some variations, the mobile computing device 110 can be configured to pull data from an application database 140 accessible via the platform server 130. In some variations, the platform server 130 can be configured to push data, obtained from the application database 140, to the mobile computing devices 110. The data obtained by the mobile computing device 110 can be associated with the location of the mobile computing device 110. For example, the data, obtained by the mobile computing device 110, can relate to a vendor, a product, or other item, that the mobile computing device 110 is near. The proximity of the mobile computing device 110 to the vendor, product, or other item, can be known from the mobile computing device 110 being within a threshold distance of a beacon 112 situated within a vendor premises, near the product, or near the other item. In this manner the data obtained by the mobile computing device 110 can be associated with beacon(s) 112 of which the mobile computing device 110 is in range.

The platform server 130 can provide virtual content (via the web server(s) 120) to the mobile computing device 110 operating a mobile application supported by the platform server 130. The client application executed by the mobile computing device 110 can be configured to cause the virtual digital data to generate virtual content items on a screen of the mobile computing device 110.

The beacons 112 can be associated with virtual content. Virtual content can be associated with a beacon's unique identifier. The virtual content can be stored and managed on an application database 140 associated with the platform server 130. In some variations, the virtual content can be stored and managed by a vendor server 150. The vendor server 150 can be in electronic communication with the web server(s) 120. The vendor server 150 can be in electronic communication with the platform server 130 through the web server(s) 120.

An entity that deploys beacons and/or is concerned with associating virtual content with beacons can obtain the unique identifier of the beacon 112. The unique identifier of the beacon 112 can be provided as being physically stamped, typed, and/or engraved onto the beacon. The unique identifier of the beacon 112 can be transmitted by the beacon 112. The entity deploying the beacon 112 can have a computing device configured to receive and decode signals emitted by the beacon 112. The computing device can be configured to obtain the unique identifier of the beacon 112 to the deploying entity.

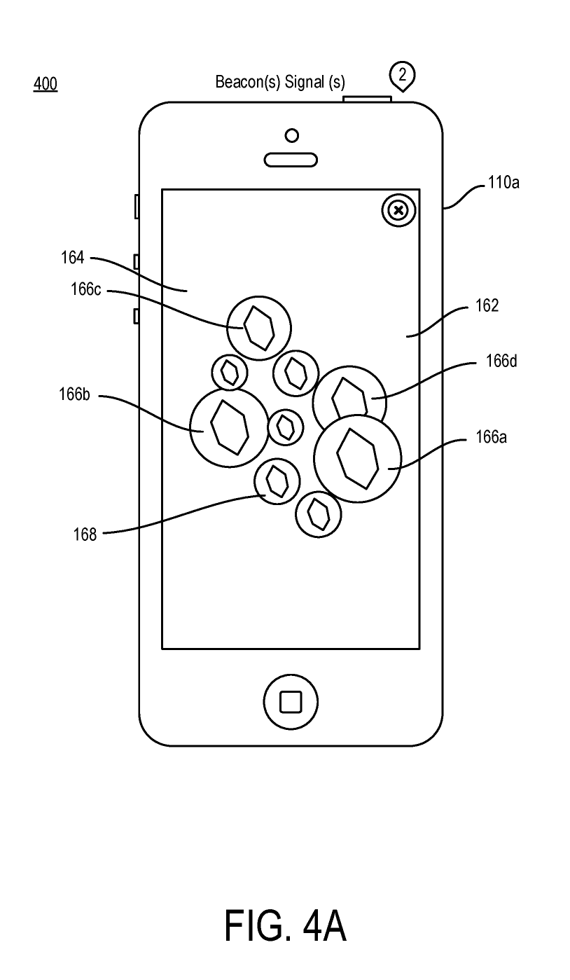

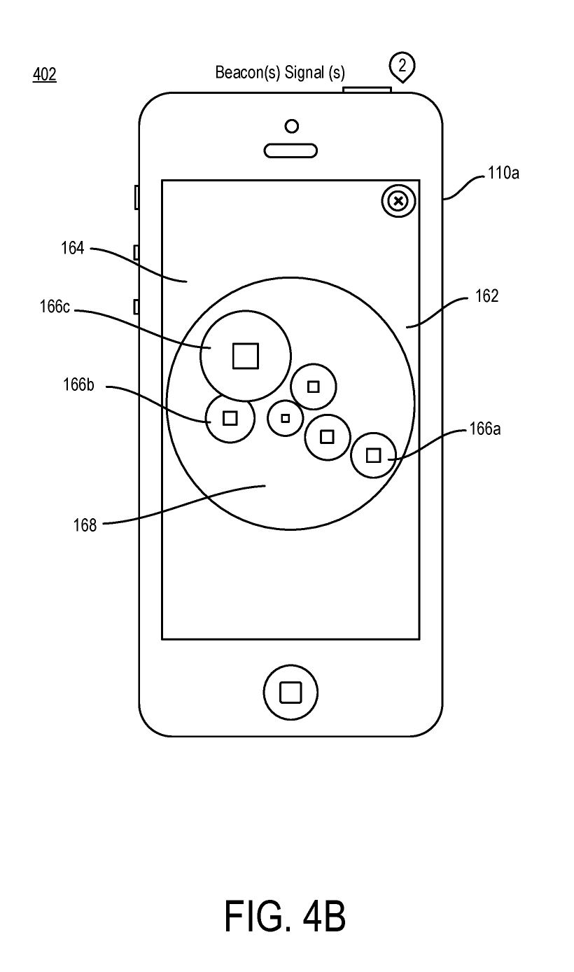

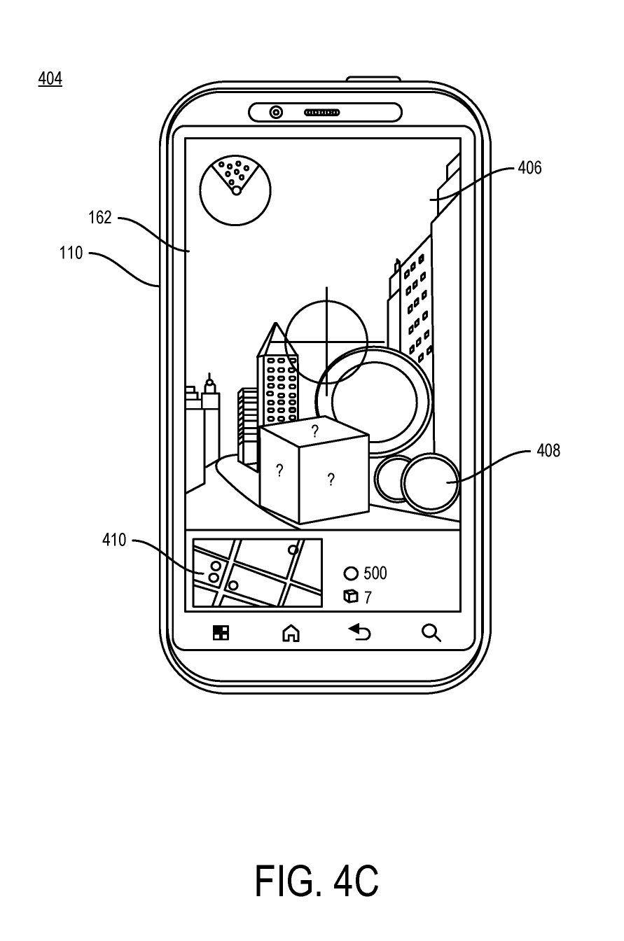

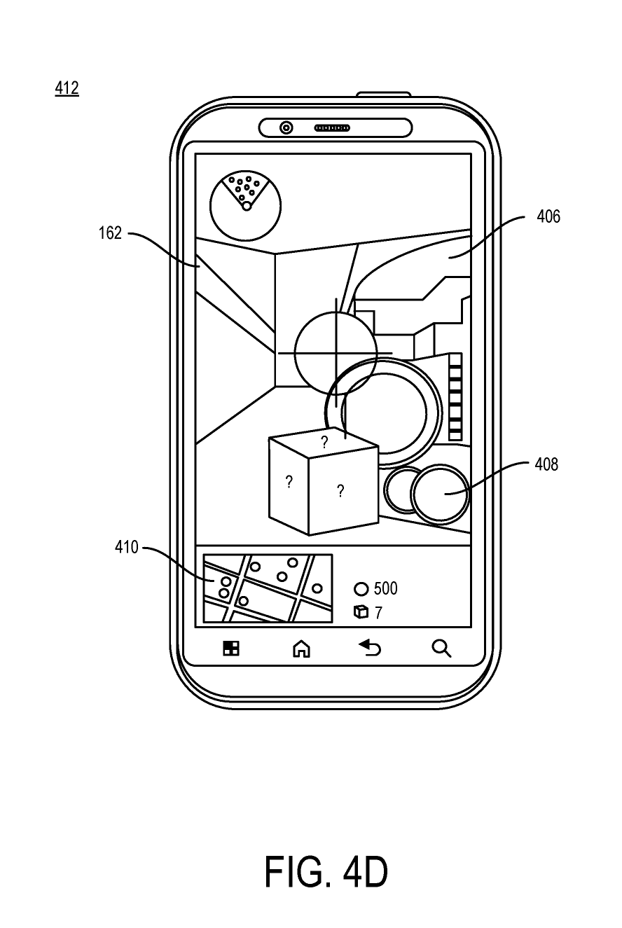

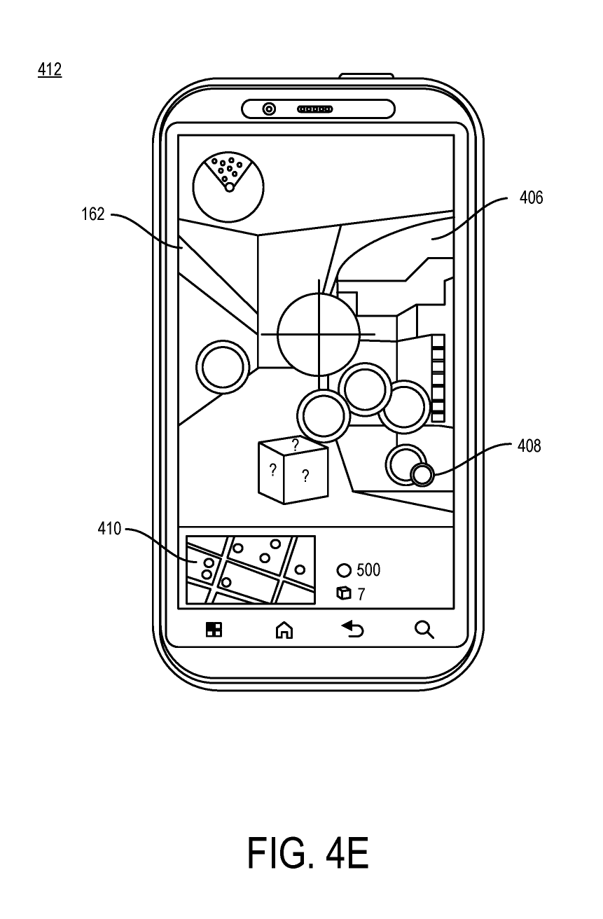

Virtual content can be associated with beacons 112 in multiple ways. Virtual content can be provided to, and maintained in, electronic storage systems associated with a platform server 130, a vendor server 150 and/or other electronic storage systems. A database can be maintained, such as an application database 140, that includes an indication of the unique identifier of the beacon 112 and the location of the virtual content associated with that unique identifier. The virtual content associated with the unique identifier of the beacon 112 can include a first virtual content item. A first virtual content item can include an icon, or graphic, as illustrated in FIGS. 4A-4E. When the mobile computing device 110 is within range of multiple beacons 112, multiple first virtual content items, associated with multiple beacons 112, can be simultaneously presented on a screen of the mobile computing device 110.

When a mobile computing device 110 receives a signal from a beacon 112, the mobile computing device can be configured, by a mobile application executed on the mobile computing device 110, to decode the signal from the beacon 112 and determine the unique identity of the beacon 112. Once the mobile computing device 110 has the unique identifier for a beacon 112, the mobile computing device 110 can be configured, by the mobile application, to obtain the virtual content associated with the unique identifier. The storage location of the virtual content can be obtained by consulting a database, such as the application database 140, that keeps a record of location of the virtual content associated with a beacon 112 against a record of the beacon's unique identity.

In some variations, virtual content can be loaded onto the beacons 112 during an initial setup of the beacons 112. The virtual content can be transmitted by the beacons 112 to the mobile computing device 110 when the mobile computing device 110 comes into range of the beacon 112. The beacons 112 can be associated with a first virtual content item. The mobile application executed on the mobile computing device 110 can be configured to cause presentation of the first virtual content item associated with a beacon 112, on a screen of the mobile computing device 110, in response to a determination that the mobile computing device 110 is within range of the beacon 112.

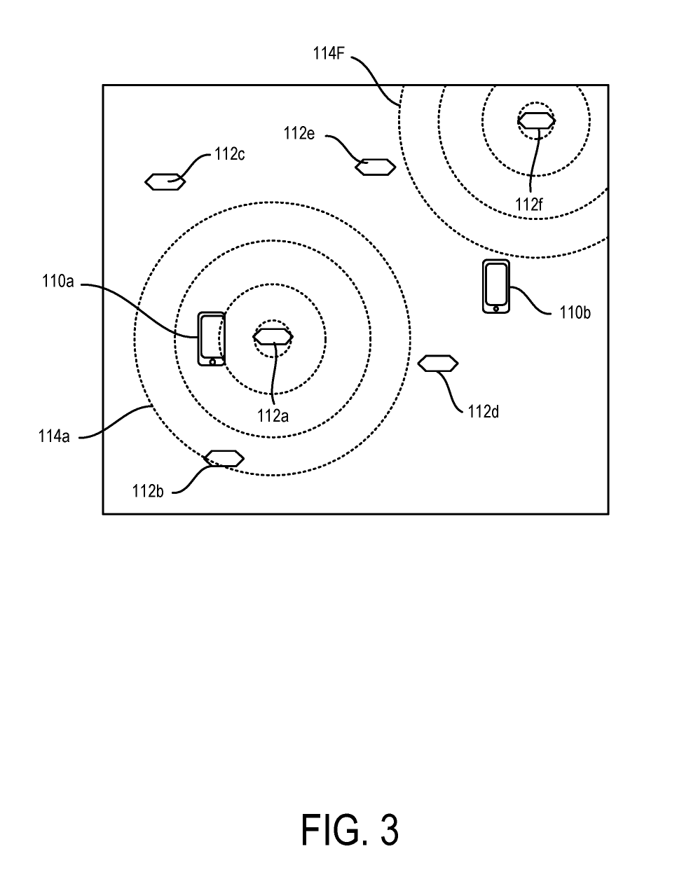

The mobile application can be configured to cause the size of the first virtual content item, presented on the screen of the mobile computing device 110, to change based on the distance of the mobile computing device 100 to the beacon 112. When the mobile computing device 110 is in range of multiple beacons 112, multiple first virtual content items associated with each of the in-range beacons 112 can be presented on a screen of the mobile computing device 110. The mobile application executed on the mobile computing device 110 can be configured to cause the size of the first virtual content items presented on the screen to be based on the relative distances between the mobile computing device 110 and the beacons 112. For example, as described in relation to FIGS. 3, 4A and 4B, a first virtual content item associated with a beacon 112 that is near to the mobile computing device 110 can be presented on the screen of the mobile computing device 110 as being bigger than the first virtual content item associated with a beacon 112 that is further away from the mobile computing device 112.

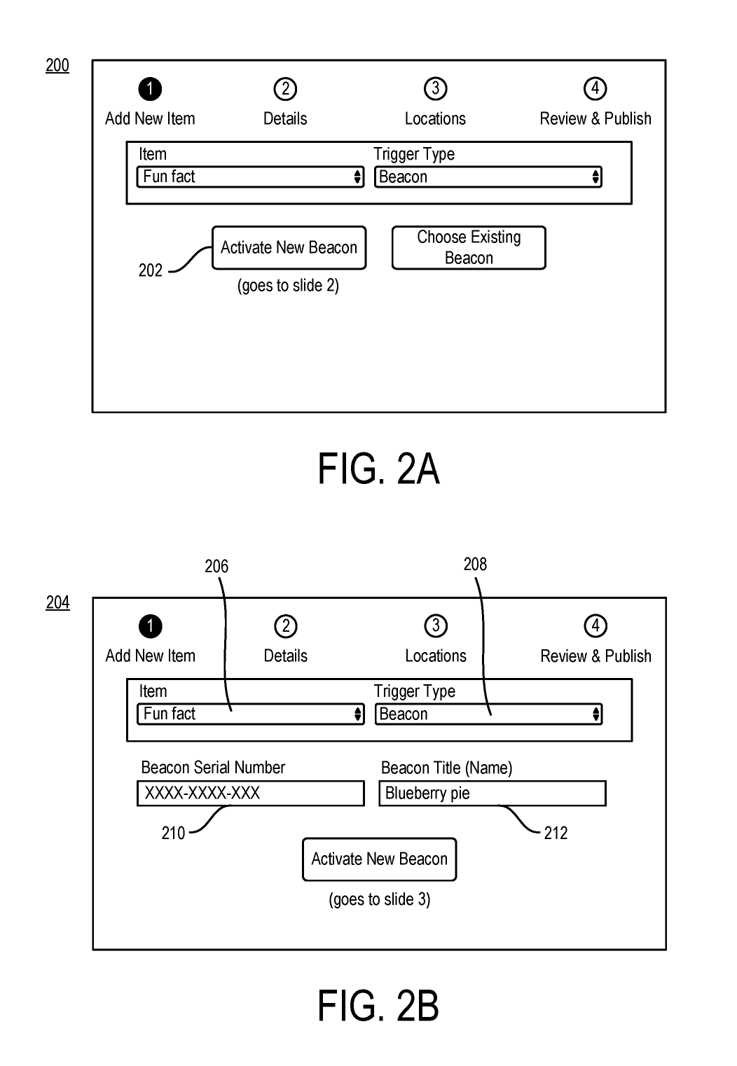

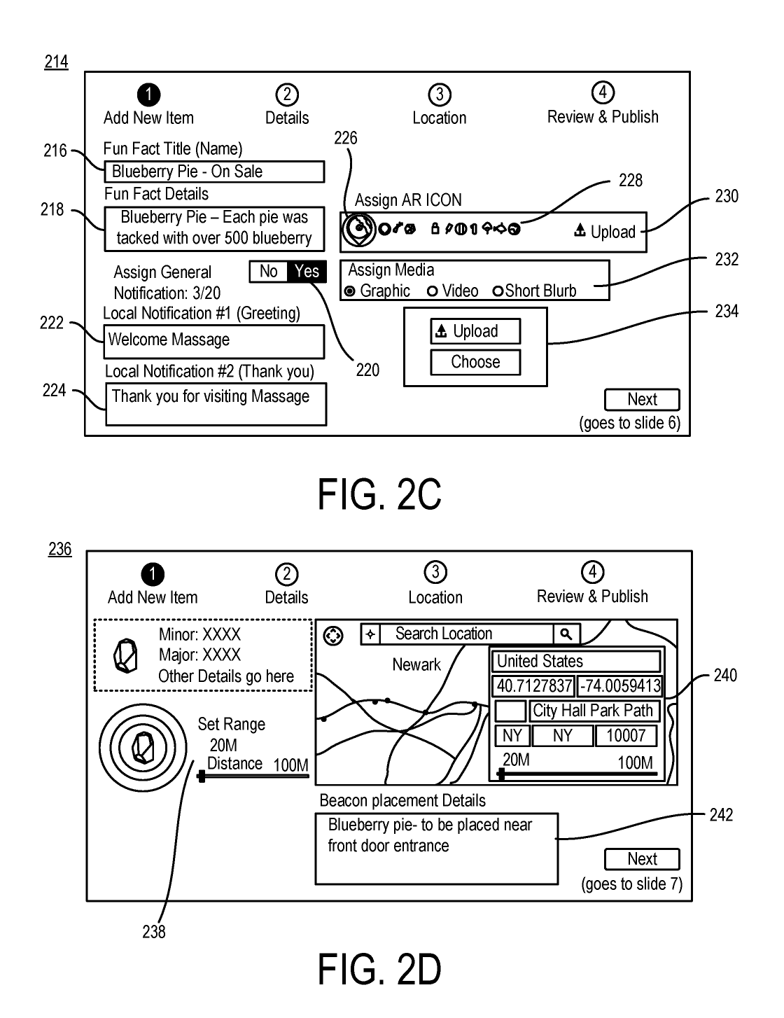

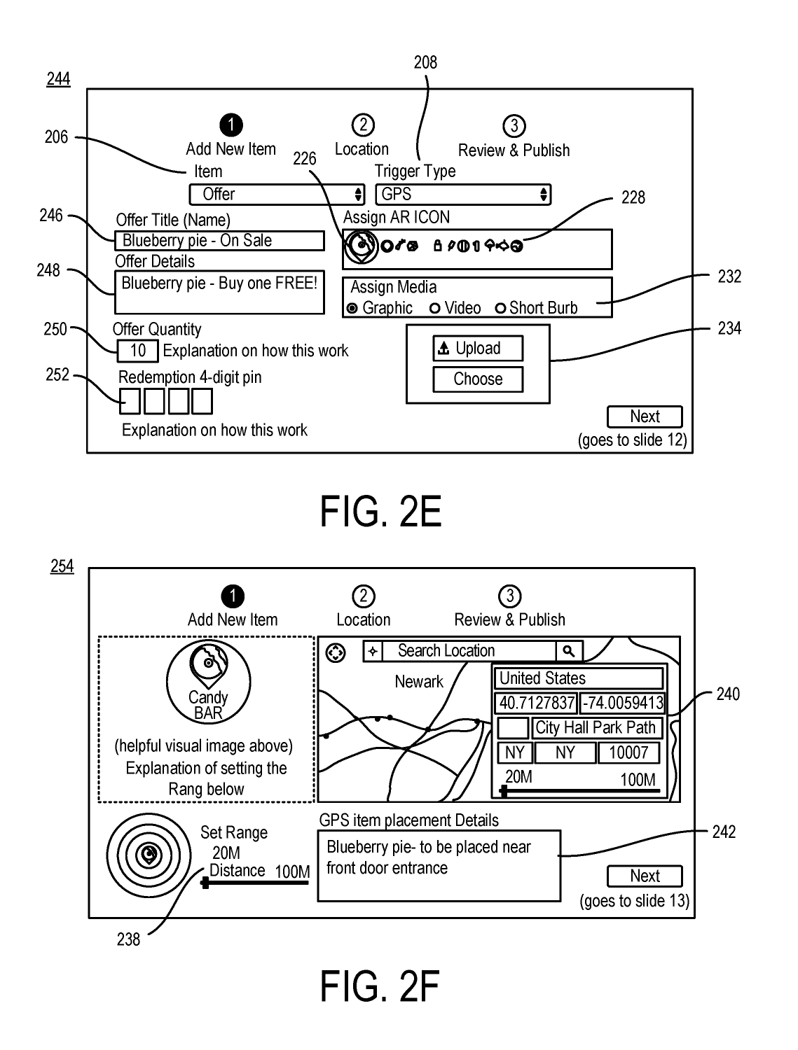

A beacon management platform can be provided to an entity that distributes and/or uses beacons 112. A beacon management platform can be a software platform executed on a computer server. The beacon management platform can be configured to facilitate the configuration and management of beacons by an entity subscribing to the beacon management platform and that distributes and/or uses beacons. An entity that distributes and/or uses beacons 112 can include, for example, a vendor for providing localized advertisements to users of beacon-enabled mobile computing devices 110, entertainment venue providers providing localized information to users of beacon-enabled mobile computing devices 110, museums providing information associated with exhibits, and the like. FIGS. 2A-2F are illustrations of visualizations of a graphical user interface of a beacon management platform configured to be presented, for example, to vendors, to facilitate vendors in the management and maintenance of a beacon(s) 112. The beacon management platform can be managed and maintained by a platform server 130. The beacon management platform can be provided, for example, to the vendor through a vendor server 150. The beacon management platform can be provided to the vendor through a vendor computing device(s) 152. The vendor computing device(s) 152 can be configured to communicate with the platform server(s) 130 through the vendor server 150. In some variations, the beacon management platform can be provided to a vendor through a vendor mobile computing device(s). The vendor mobile computing devices can be configured to communicate with the platform server 130 through the web servers 120.

The beacon management platform can include an interface (e.g., a WYSIWYG tool set allowing a vendor administrator to drag and drop content to specific locations on a map and/or on a rendered virtual reality stream, etc.) to, for example, a vendor, allowing vendor administrators to specify content to be placed with various beacons 112 and/or geo-locations for presentation to users on screens of mobile computing devices 110.

The beacon management platform provider, for example the operator of the platform server 130, can charge vendors to place such content according to a variety of models including cost-per-click, cost-per-impression, revenue sharing such as affiliate relationships, and other revenue generation models. The beacon management platform provided, for example to a vendor, can be configured to facilitate the vendor setting certain limits. For example, the vendor can specify certain upper limits (on an impression-by-impression basis or as part of an overall budget) on how much it spends placing content within the beacon management platform and/or presented to users of the mobile application. The beacon management platform can be configured to facilitate the setting of advertising budgets by/for vendors. In variations where the virtual content provided to mobile computing devices 110 is in the form of points, elements, or tokens won during a user's participation in a game, a currency enforcement mechanism can be provided that is premised on vendor charges associated with the amount of in-game elements gathered. The real-world value of game elements won by users can be based upon a fixed value or valued by a bidding algorithm depending upon the in game element type. Game elements associated with each beacon and/or geo-location may differ in bidding competitiveness and therefor, some in-game elements can maintain different valuations for vendors.

FIG. 2A is an illustration of a user interface 200 to facilitate selecting an activation of a new beacon or managing an existing beacon. A vendor administrator of the vendor platform can select the “Activate New Beacon” virtual button 202 to activate a new beacon 112.

FIG. 2B is an illustration of a user interface 204 configured to facilitate activating a new beacon 112. The vendor administrator can select the theme 206 for the beacon. The theme 206 of the beacon can dictate the type of virtual content that will be presented on a mobile computing device 110 when it comes within range of the beacon. The vendor administrator can select the whether virtual content will be presented on the screen of the mobile computing device 110, running the mobile application, based on the geolocation of the mobile computing device 110 or the proximity of the mobile computing device 110 with a beacon. Each beacon can include a unique identifier. The unique identifier can be a Beacon Serial Number. A vendor administrator can enter the beacon's unique identifier into the text box 210. In some variations, beacons 112 can include a scanable code. The scanable code can include a QR code, bar code, alphanumeric characters and/or other scanable code. The scanable code can be unique to the beacon and can correspond with a unique identifier for the beacon. The unique identifier obtained by scanning the scanable code can be provided to the platform for automatic inclusion in the text box 210. The vendor administrator can assign a name 212 to the beacon 112 to facilitate easy management of the beacon 112.

A vendor advertisement can be dragged and dropped using a graphical user interface. The vendor advertisement can be associated with a beacon and/or a geo-location on a map. The advertisement can contain text, animation, and/or graphics, and the like. Thereafter advertisements/rewards can be converted into game items stored on web servers 120, mobile computing devices 110, vendor servers 150, platform servers 130, and the like. Vendor advertisements can be sent to a mobile client and/or vendor rewards can be sent to a mobile computing device.

FIG. 2C is an illustration of a user interface 214 configured to facilitate assigning a parameter(s) to a virtual item associated of the beacon 112. The vendor administrator can assign a name 216 to the virtual item associated with the beacon 112. The name 216 can be a caption that accompanies the virtual item on the display of a mobile computing device 110. The vendor administrator can include additional information 218. The additional information 218 can be accessed by a user of the mobile computing device 110 in response to an interaction by the user with the virtual item associated with the beacon 112.

The user interface 214 can be configured to facilitate selection of whether the beacon 112 will be included in the visualization of the beacons 112 on the screen of mobile computing devices within range of the beacons 112 (as shown in FIG. 3). Selection of whether the beacon 112 will be included in the visualization of the beacons 112 can be through a virtual switch 220.

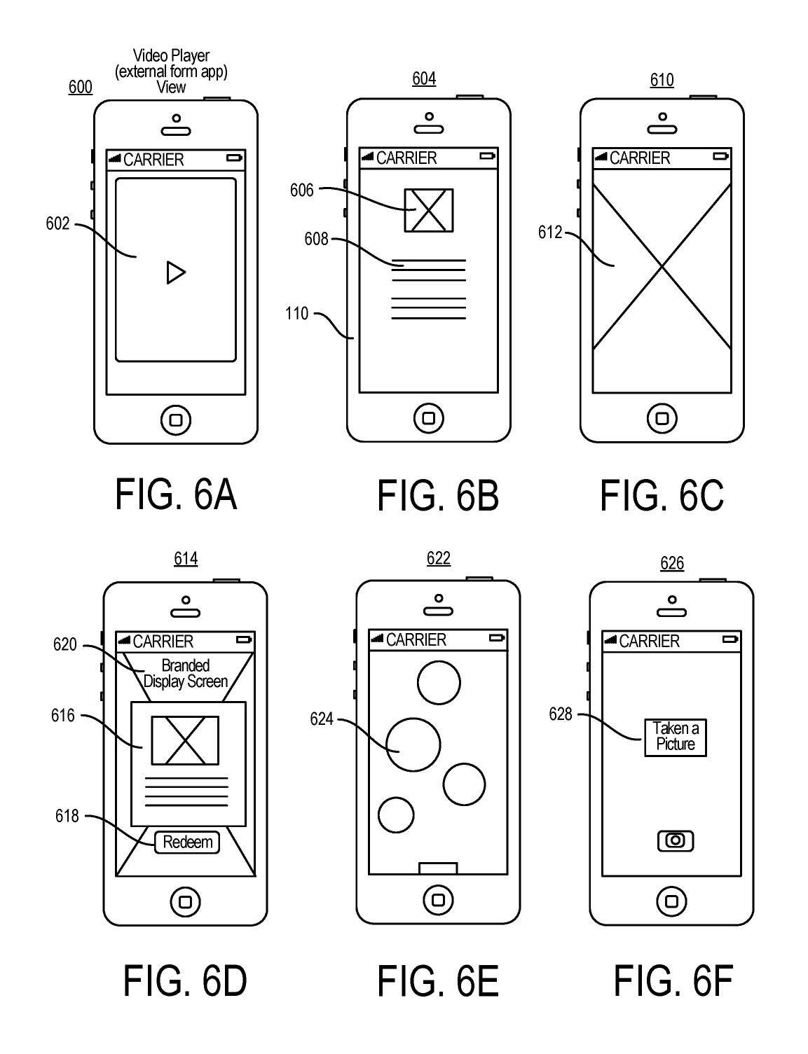

A vendor administrator can define a first notification 222. The first notification 222 can be a notification presented to a user of a mobile computing device 110 in response to the mobile computing device 110 coming within range of the beacon 112 (as illustrated in FIGS. 6B and 6D). A vendor administrator can define a second notification 224. The second notification 224 can be a notification presented to a user of a mobile computing device 110 in response to the mobile computing device 110 leaving the range of the beacon 112 (as illustrated in FIGS. 6C and 6D).

A vendor administrator can select the virtual item 226 to represent with the beacon 112. The virtual item 226 can be presented to a user on a screen of a mobile computing device 110 when the mobile computing device 110 is within range of the beacon 112 (as shown in FIGS. 4A-4E). The virtual item 226 can be selected from a set of virtual items 228. The virtual item 226 can be uploaded through interaction with a virtual upload button 230. The set of virtual items can include virtual items branded to the particular vendor that is setting up the beacon.

The user interface 214 can be configured to facilitate selection of whether to associate media content to the beacon 112. The vendor administrator can select a type of media using selectable media assignment switches 232. The media content intended to be associated with the beacon 112 can be dragged into an upload panel 234. The upload panel 234 can be configured facilitate the vendor administrator dragging files into the upload panel and having them uploaded to the electronic storage accessible by the mobile computing devices 110 via web servers 120.

FIG. 2D is an illustration of a user interface 236 configured to facilitate assigning parameters to the beacon 112. For example, the range 238 and geo-location 240 of the beacon 112 can be set. Placements notes 242 can be input into the platform to be maintained by the platform facilitated by the platform server 120.

FIG. 2E is an illustration of a user interface 244 of the platform configured to facilitate assigning of an offer(s) to the beacon 112 or to a geo-location. A vendor administrator can select a virtual item type 206 for the virtual item associated with the beacon. In the example illustrated in FIG. 2E, the virtual item type is an offer. The vendor administrator can select whether the virtual item will be associated with a beacon or a geo-location through selecting a trigger type 208. The vendor administrator can provide an offer name 246. The offer name 246 can be a caption that appears on a screen of a mobile computing device 110 the mobile computing device 110 detects that it is within range of a beacon 112 or within a threshold distance from a geographic location. The vendor administrator can enter in offer details 248. The offer details can be provided to the mobile computing device 110 in response to an interaction, by the user, with the virtual item presented on a screen. In some variations, the vendor desires to include a limited number of items in the offer. The vendor administrator can input the number of offers 250 that a vendor wishes to provide and/or have accepted by users of the mobile computing device 110 having a mobile application.

In some variations, a PIN number 252 may be required to accept the offer provided by the vendor. The PIN number 252 can be transmitted to the mobile computing device 110 for presentation on the mobile computing device 110. Requiring a PIN number 252 to redeem the offer and providing it to only those mobile computing devices 110 who are in-range of the associated beacon 112 can facilitate ensuring that only those people who visited a particular location can accept the offer.

FIG. 2F is an illustration of a user interface 254 of the platform configured to facilitate assigning a virtual item to a geographical location.

The platform can also include a custom promotional integration module that is facilitated in application form through various in-application elements including but not limited to animated, image, text, and video data. In-application elements serve as representations for offers, promotions, advertisements, and mediated reality environmental elements that are placed strategically in the mediated reality application. The location of these in-application elements can be based on localization information such as the mobile computing device 110 being in range of a beacon 112, or through geo-location coordinates guided by application administrators as well as vendors but can also be rendered through pre-loaded image based objects found throughout the real world. All in-application elements in vendor promotional formats that require the action of redemption can be automatically sent to user upon collection on the mobile device via electronic messages and through APIs built to third party sites, such as social networking websites.

The current subject matter can also be used to provide custom sweepstakes and/or complete alternate user experience opportunities utilizing the platform while facilitating custom campaigns and promotional opportunities with the application. Adventures and functionalities enable vendors to feature monthly sweepstakes, challenges, scavenger hunts, and other user experience specific methodologies. These adventures are activated for use for those users presently in geographical proximity to that event. Mobile users can opt-in to these adventures within their geographic radius and compete in them. Adventures can be co-branded, affiliate branded, or privately labeled for vendor use.

Various types of analytics and reporting can be provided that characterize user's activities and/or the effectiveness of vendor place content. For example, one or more of the following can be provided: in depth analytics, painted recommendations for maximizing exposure on the game, aggregation of data compiled from the game that will help the advertiser, in depth consumer behavior data, data on how the consumer interacts with the vendors brand, click-through response rates, and offerings collection data.

FIG. 3 is an illustration of mobile computing devices 110a-b in the vicinity of multiple beacons 112a-f The beacons 112a-f have a beacon range. Beacon 112a has a beacon range 114a. Beacon 112f has a beacon range 114f When a mobile computing device 110a-b is within range of the signals emitted by the beacons 112a-f, a mobile application executed on the mobile computing device 110a-b can be configured to facilitate presentation of a first virtual content item associated with that beacon to be presented on a screen of the mobile computing device 110a-b.

As illustration in FIG. 3, mobile computing device 110a is within range of beacons 112a-d. Mobile computing device 110a is not within range of beacons 112e-f. Consequently, a mobile application executed on mobile computing device 110a can be configured to facilitate presentation of first virtual content items, on a screen o the mobile computing device 110a, associated with beacons 112a-d.

FIG. 4A is an illustration 400 of a screen shot (also referred to as a user interface or user interface view) showing visualizations associated with beacons 112a-d on a screen 162 of the mobile computing device 110a. The mobile application can be configured to provide visualizations associated with the in-range beacons 112a-d. The visualizations can include the first virtual content item. Individual beacons 112a-d can be represented in the user interface view by individual first virtual content items 166a-d. The first virtual content items 166a-d can be, for example, icons. The mobile application can be configured to cause the mobile computing device 110a to present the first virtual content items 166a-d through a graphical user interface 164 on a screen 162 of the mobile computing device 110a. The visualization for each beacon 112a-d can include additional virtual content 168 associated with each individual beacon 112a-d.

The mobile application can be configured to cause the first virtual content items 166a-d for the beacons 112a-d to have a size in the graphical user interface 164 relative to the distance of the mobile computing device 110a to the beacons 112a-d. In some variations, the first virtual content item can include a series of halos, or other graphical indicator, around additional virtual content 168. The additional virtual content 168 may have a static size. The halos, or other graphical indicator, however, may increase or decrease in size based on the distance of the mobile computing device 110 to a particular beacon 112.

With the example illustrated in FIG. 3, the mobile computing device 110a is closest to beacon 112a. Consequently, the mobile application is configured to cause the first virtual content item 166a associated with beacon 112a to appear as the largest first virtual content item 166a in the graphical user interface 164. The first virtual content item 166d associated with beacon 112d is the smallest first virtual content item 166d due to the mobile computing device 110a being furthest away from the beacon 112d. Beacons 112e and 112f do not have corresponding visualizations in the graphical user interface 164 because the mobile computing device 110a is out of range of those beacons.

FIG. 4B is an illustration 402 of a screen shot showing visualizations associated with beacons 112a-d on a screen 162 of a mobile computing device 110a, similar to FIG. 4A but after the mobile computing device 110a has moved closed to beacon 112c and further away from beacon 112a. The first virtual content item 166a associated with the beacon 112a is now smaller compared to when the mobile computing device 110a was closer to the beacon 112a. The first virtual content item 166c associated with the beacon 112c is now larger compared to when the mobile computing device 110a was closer to beacon 112a. the first virtual content item 166d associated with the beacon 112d has now been removed from the graphical user interface 164 because the mobile computing device 110a has moved out of range of the beacon 112d.

The resizing of the first virtual content items 166a-d can be substantially continuous. The first virtual content items 116a-d can resize in a substantially continuous manner as the mobile computing device 110a moves within the environment containing the beacons 112a-f. In some variations, the resizing of the first virtual content items 166a-d can be intermittent. The first virtual content items 116a-d will periodically resize based on the periodic determination of the location of the mobile computing device 110a relative to to the beacons 112a-f.

FIG. 4C is an illustration 404 of a screenshot of a screen of a mobile computing device 110 illustrating a field of a vision 406 on a screen 162 of the mobile computing device 110. The field of vision 406 can be provided through a camera of the mobile computing device 110. The field of vision 406 can include a virtual content item(s) 408 that overlay the view provided by the field of vision.

These virtual content items 408 remain fixed or relatively fixed over real-world objects presented in the field of vision 406 as the mobile computing device 110 is moved in relation to such elements 408. FIG. 4C illustrates a mediated reality streaming camera view in which the in-application elements include a question box, a gold medallion, and gold coins. In addition to the mediated reality views a map 410 can be concurrently displayed that identifies the location of the corresponding mobile computing device 110.

FIG. 4D is an illustration 412 of a screenshot of a screen of a mobile computing device 110 illustrating a field of a vision 406 on a screen 162 of the mobile computing device 110, similar to the illustration 404 of FIG. 4C, but with the mobile computing device 110 within a vendor premises.

FIG. 4E is an illustration 414 of a screenshot of a screen of a mobile computing device 110 illustrating a field of a vision 406 on a screen 162 of the mobile computing device 110, similar to the illustration 412 of FIG. 4D, but with the mobile computing device 110 having moved within the vendor premises. Changing of the location of the mobile computing device 110 can cause a change in the size of the elements 408 overlaid on the field of vision 406 presented on the screen 162 of the mobile computing device 110.

The virtual content items in the mediated reality streaming camera view can a medallion, coins, merchant coupons, billboards, merchant/vendor branded medallions, merchant branded alternate mode (i.e., an alternate reality overlaid on the field of vision of the camera), sweepstakes, contest, scavenger hunt and/or other virtual items.

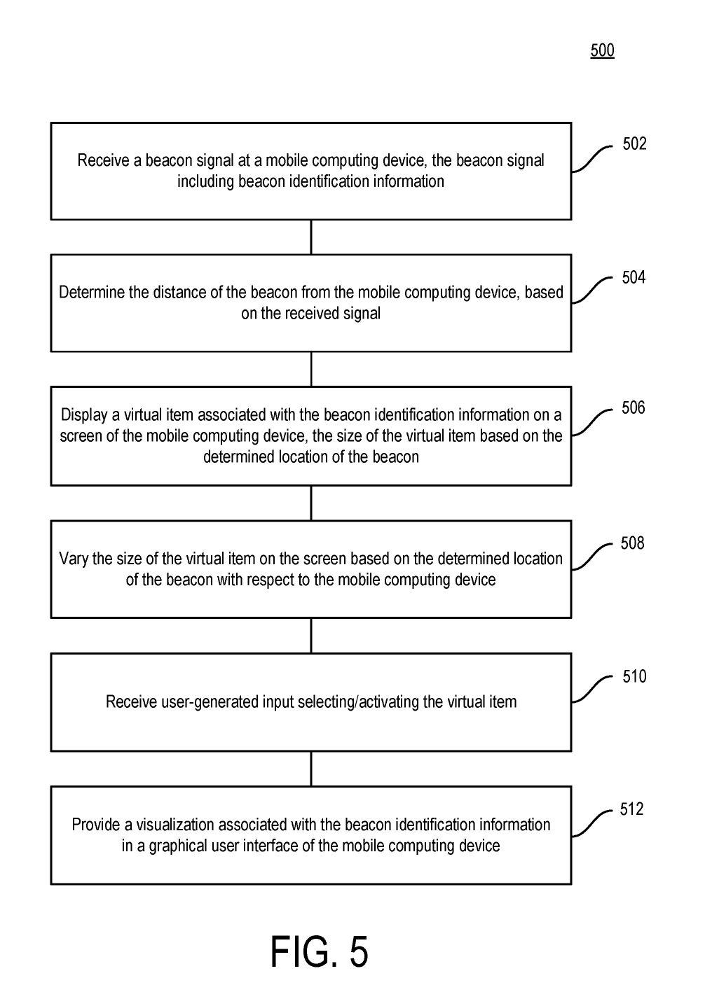

FIG. 5 is a process flow diagram 500, illustrating a method of providing content to a mobile computing device 110 based on the proximity of the mobile computing device 110 to a beacon 112. It will be appreciated that one or more of the aspects described with such workflow can be omitted depending on the desired implementation.

At 502 a beacon signal, emitted by a beacon 112, can be received at a mobile computing device 110. The beacon signal can indicate the identity of the beacon 112. For example, the beacon 112 may include identification information for the beacon 112. Beacon identification information can include a unique code, such as a serial number for the beacon 112. At 504, the distance of the beacon 112 from the mobile computing device 110 can be determined. The distance of the beacon 112 from the mobile computing device 110 can be determined based on signal strength, and the like, and/or determined based on time stamp data carried by the signal emitted by the beacon 112.

At 506, a virtual content item associated with the beacon identification information can be displayed on a screen of the mobile computing device 110 (as shown in FIG. 4A). The beacon identification information can be transmitted, by the mobile computing device 110, to the platform server 130. This transmission can be facilitated by an application executed by the mobile computing device 110. In some variations, the platform server 130 can be configured to obtain the virtual content item associated with the beacon 112 from an application database 140. The virtual content item can be transmitted to the mobile computing device 110 through web server(s) 120. In some variations, a vendor server 150 can facilitate providing the virtual content item to the mobile computing device 110. The vendor server 150 can be configured to manage the virtual content items associated with the beacons 112 that the vendor has deployed.

At 508, the mobile computing device 110 can be configured to vary the size of the virtual content item, associated with a beacon 112 and displayed on the screen of the mobile computing device 110, based on the varying distance between the beacon 112 and the mobile computing device 110 (as shown between FIGS. 4A and 4B). The closer the mobile computing device 110 is to a beacon 112 the larger the virtual content item associated with that beacon will become. When a mobile computing device 110 moves away from a beacon 112, the virtual content item associated with the beacon will become smaller, and other virtual content items associated with other beacons will become larger as the mobile computing device 110 moves toward them. For example the mobile computing device 110 may update the view presenting the virtual content item to show the varied size in accordance with distance.

At 510, a user-generated input can be received through the mobile computing device 110. In some variations, the mobile computing device 110 can include a touch screen. The touch screen can be configured to respond to a user's touch. If a user touches the touch screen at the location of a virtual content item, the mobile application can cause the virtual item to become activated. Activating a virtual content item in the mobile application can facilitate presentation of additional virtual content on the screen of the mobile computing device 110. For example, in response to a user interacting with a first virtual content item through a touch screen of the mobile computing device 110, video content for a vendor can be presented to the user through a graphical user interface on the screen of the mobile computing device 110. The additional virtual content can be any type of virtual content. For example, the additional virtual content can be video content, multimedia content, social media content, advertising content, information, game content, and the like.

At 512, a visualization of media content associated with the beacon 112 can be provided on a screen of the mobile computing device 110. The visualization of the media content in the screen of the mobile computing device 110 can replace any previous visualization on the screen of the mobile computing device 110. The visualization of the media content on the screen of the mobile computing device 110 can replace a portion of any previous visualization on the screen of the mobile computing device 110. The media content can be associated with the vendor who deployed the beacon 112. Examples of media content that can be presented on the screen of the mobile computing device 110 can include the examples in FIGS. 6A to 6F.

FIGS. 6A-6F illustrate various screen shots of media content provided to the mobile computing devices after an interaction by a user with a visualization of a beacon. FIG. 6A illustrates a screen shot 600 showing a visualization of video media content 602. The video media content 602 can be provided through a video playing application, or a video media content providing application (for example, YouTube, and the like), separate from the mobile application facilitating presentation of visualization of the beacons 112.

FIG. 6B illustrates a screen shot 604 showing a visualization of multiple types of media content simultaneously on the screen of a mobile computing device 110. For example, image media content 606 can be presented on the screen of the mobile computing device 110 as well as text media content 608. The text media content 608 can be complimentary to the image media content 606. The media content in such a visualization can be provided by the platform mobile application or an application separate from the platform application. The media content can overlay a portion of the visualization of the screenshot previously presented on the screen of the mobile computing device 110.

FIG. 6C illustrates a screen shot 610 showing a visualization of image media content 612 occupying the whole screen of the mobile computing device.

FIG. 6D illustrates a screen shot 614 showing a visualization of an offer on the screen of a mobile computing device. The offer can include video media content, image media content, text media content, and/or other media content. The offer can include multiple types of media content. The visualization can include a branded background 620. The virtual content for the branded background 620 can be provided to the mobile computing device 110 (as shown in FIG. 1) from the platform server 130 through the web server(s) 120. In some variations, the virtual content for the branded background 620 can be provided by the vendor server 150 through the web server(s) 120 with, or without, the involvement of the platform server 130.

FIG. 6E illustrates a screen shot 622 showing a visualization of a game 624 on the screen of a mobile computing device. The game can include vendor branding. The game can be configured to facilitate the earning of electronic rewards. The electronic rewards can be redeemed for media content items, real world items, and/or other items. For example, electronic rewards can be redeemed for a digital music download, a mobile application, and/or other virtual content.

FIG. 6F illustrates a screen shot 626 showing a visualization of a camera field of view 628 on the screen of a mobile computing device. The mobile application can be configured to access a camera of the mobile computing device and cause the presentation of the camera field of view 628. A user can take a photograph of a vendor item associated with the beacon from which they activated the media content. The mobile application can facilitate sharing the photograph on social media websites or in social media applications. The platform server 130 can be configured to link with social media websites and applications. A user can create an account with the platform. The user's platform account can be associated with the user's social media accounts. The platform server 130 can be configured to push the photograph taken by the user to the social media websites and applications for display on a wall or timeline associated with the user. In some variations, the mobile application can be configured to generate metadata to accompany the photograph. The metadata can include the identity of the beacon, an identity of the object photographed, an identity of the vendor, a location of the field of view photographed and/or other information. The platform server 130 can be configured to cause some or all of the information to be displayed on the social media websites or applications alongside the shared photograph.

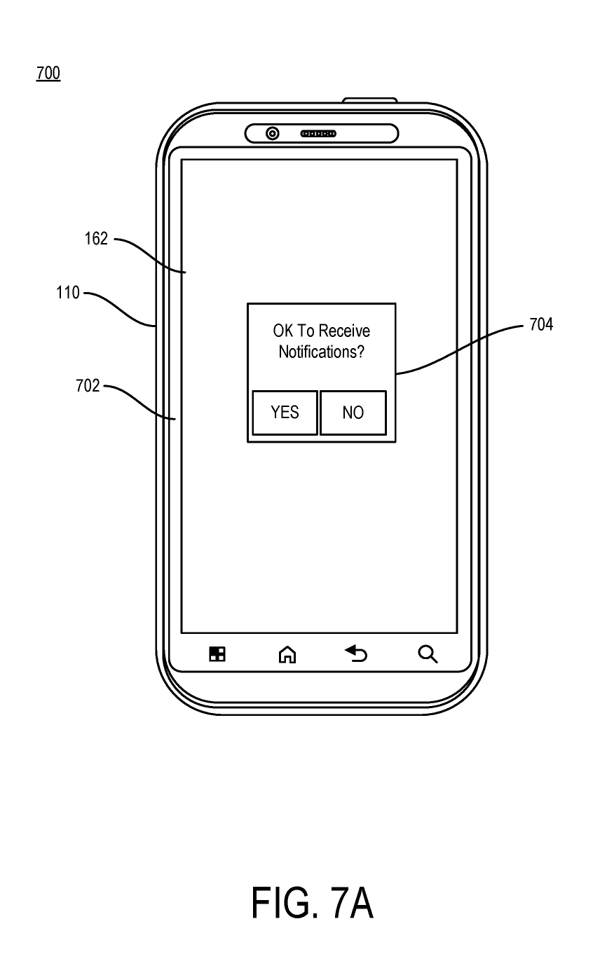

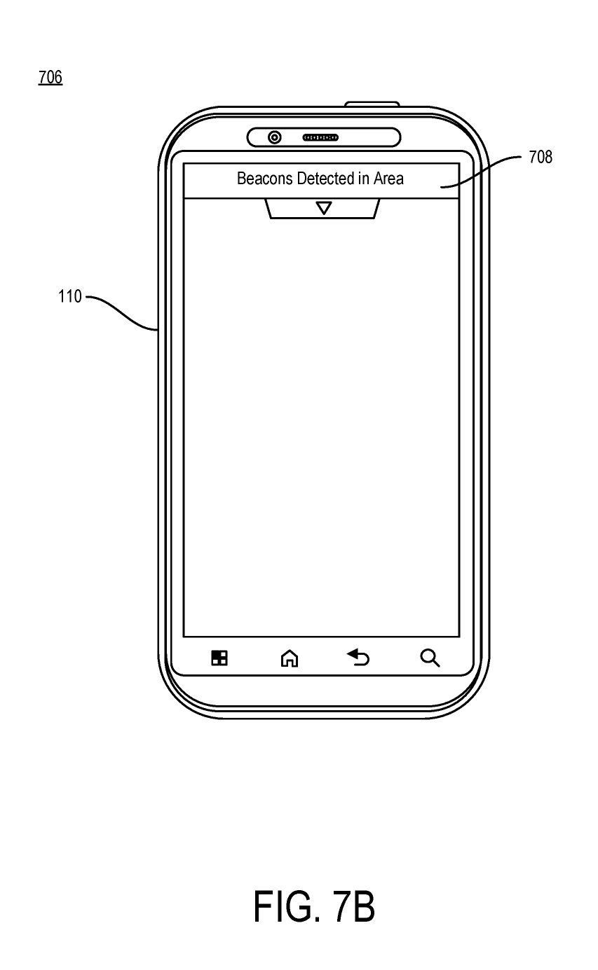

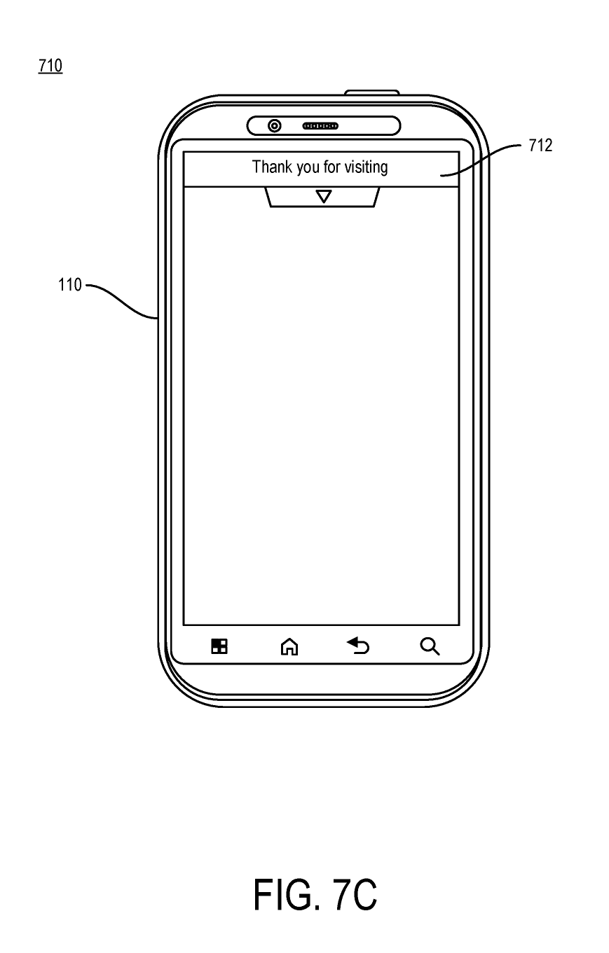

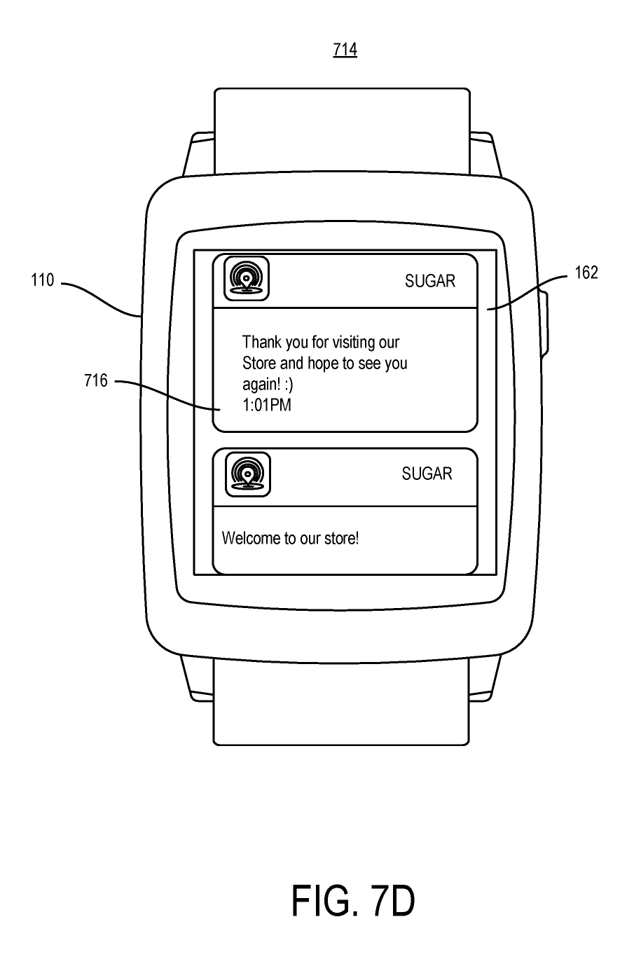

FIGS. 7A-7C provide various screenshots of a graphical user interface 710 associated with providing notifications on the screen of the mobile computing device 110 regarding beacons 112. FIG. 7A is an illustration 700 of a screenshot of a graphical user interface 702 associated with a mobile application for execution on the mobile computing device 110. When the mobile application is initially executed on the mobile computing device 110 the mobile application can be configured to cause presentation of a dialogue box 704 requesting permission to provide notifications to the user on the screen 162 of the mobile computing device 110.

When a user of the mobile computing device 110 selects not to receive notifications the user will not be notified through the mobile computing device 110, when they are within the vicinity of a beacon 112. When a user of the mobile computing device 110 selects to receive notifications, the mobile application executed on the mobile computing device 110 can be configured to cause a notification to be presented on the screen 162 of the mobile computing device 110 when the mobile computing device 110 comes into range of a beacon 112.

FIG. 7B is an illustration 706 of screenshot of a visualization on a mobile computing device 110 providing a notification 708 that the mobile computing device 110 is within range of a beacon(s) 112.

FIG. 7C is an illustration 710 of a screenshot of a visualization on a mobile computing device 110 providing a notification 712 acknowledging the user's visit to a location associated with a beacon(s) 112. When a mobile computing device 110 moves out of range of the beacons 112 associated with a particular entity, the mobile application can be configured to cause a notification 712 to be presented on the screen 162 of the mobile computing device 110. An exemplary notification can be an acknowledgement or a pleasantry associated with the user's visit to the entity's establishment.

FIG. 7D is an illustration 714 of a screenshot of a visualization on a mobile computing device 110 providing a notification 714 acknowledging the user's visit to a location associated with a beacon(s) 112. In this example, the mobile computing device 110 is a smartwatch. In some variations, the smartwatch can be configured to receive signals emitted by the beacons 112. The smartwatch can be configured to execute a mobile application configured to cause the smartwatch to present notifications on a screen 162 of the smartwatch. In some variations, the smartwatch can be configured to electronically communicate with another mobile computing device that is capable of receiving signals emitted by the beacons 112. The other mobile computing device can transmit instructions to the smartwatch to provide such notifications.

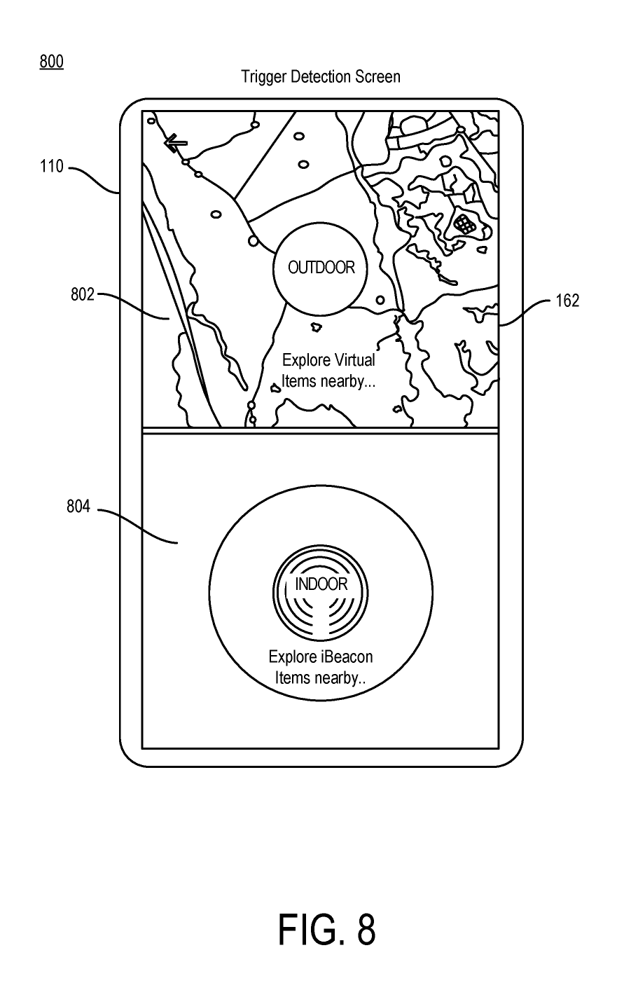

FIG. 8 is an illustration 800 of a graphical user interface 802 presented on a screen 162 of the mobile computing device 110. The graphical user interface 802 can be configured to facilitate selection of a mode of operation for the mobile computing device 110. The mobile computing device 110 can be configured to determine its location based on the relative location of beacons 112 and/or localization technologies.

The mobile application can be configured to determine the mode of operation. The mobile computing device 110 can be configured to determine its location using geo-location technologies. When the mobile computing device is determined to be at a location near beacons, the mobile application can cause the mobile computing device to receive beacon signals and receive in a beacon mode. When the mobile computing device is determined to be at a location remote from any beacons, the mobile application can be configured to cause the mobile computing device to receive geo-location signals and operation in a geo-location mode.

The mobile computing device 110 can include a localization technology such as GPS (it will be appreciated that other technologies may be utilized to identify the location of the mobile computing device 110, and as such, references to GPS herein should only be considered as an example localization technology as other technologies such as triangulation and social check-ins can be used, such as beacon location technology, the Global Navigation Satellite System (GLONASS), GPS I, GPS III, the BeiDou Navigation Satellite System, the Galileo Navigation Satellite System (GNSS), and the like). The mobile computing device 110 can include client applications that enable the streaming of the field of vision captured by the camera of the mobile computing device 110, to a platform server(s) 130 via the intervening web server(s) 120. In addition to the streaming visual data, localization information (e.g., GPS coordinates, and the like) can be transmitted to the platform server 130.

The platform server 130 can be configured to facilitate the provisional of virtual content to the mobile computing device 110 based on a location of the mobile computing device 110. Virtual content can be associated with locations. When the mobile computing device 110 determines that it is at a particular location the mobile application can be configured to cause the mobile computing device 110 to transmit data to the platform server(s) 130 that includes the location information. The platform server(s) 130 can be configured to facilitate presentation of virtual content associated with that location on a screen of the mobile computing device 110.

In some variations, the virtual content items can be presented on a screen of a mobile computing device 110 by overlaying the virtual content items onto a scene captured by the camera and presented on the screen. As used herein, an overlay is sometimes referred to as a virtual content item (as it is illustrated in the graphical user interface or view of the mobile computing device 110).

As the virtual content items can be associated with specified geo-locations—changing the field of vision (e.g., moving 120 degrees in one direction) will cause the position of the overlays to be fixed at the specified geo-locations even if such geo-locations exit the field of vision. This will cause the overlays to also exit the field of vision.

In one variation, the virtual digital data can be used by the platform server(s) 130 to provide a geo-location based promotional platform and protocol that is connected through the mediated reality browser (on a client application on the mobile computing device 110). The geo-location based promotional platform can include hyper geo-location technology. Hyper geo-location technology can include geo-location technology enhanced by additional location information. For example, a mobile computing device 110 can include a GPS receiver facilitating the determination of the GPS coordinates of the mobile computing device. The mobile computing device 110 can be configured to receive additional signals from other mobile computing devices 110 and/or fixed beacons with known locations. The additional signals can carry data that facilitates fine-tuning of the location of the mobile computing device 110.

In some variations, the user experience using the platform can rely on game theory and other customer engagement tools to encourage use of the platform. For example, the physical location of the user (as determined by the mobile computing device 110) can be used to deliver tailored additional virtual content and/or rewards. The content can be anything ranging from discounted goods/services, advertisements, tokens, specialized audiovisual contents, and the like.

The mobile application provided to and executed on mobile computing devices 110 can include vendor-brandable elements. The vendor-brandable elements can be configured to include different virtual content when encountering beacons from different vendors. For example, the vendor-brandable elements can include a banner, virtual content items representative of the beacons, mobile application loading screens, and the like. Virtual content items representative of the beacons for one vendor can have a different shape, color, or appearance compared to virtual content items representative of beacons for another vendor In some variations, the mobile application can be specific to a particular vendor and only function when in range of a beacon activated by that particular vendor.

The mobile application can include vendor themes. For example, a vendor theme can dictate a color scheme for the mobile application, the type of media content that can be presented through the mobile application and other features that can change the look and feel of the mobile application. For example, when the mobile computing device 110 is within range of a beacon from one vendor, the mobile application can be configured to be presented having a blue color pallet, when the mobile computing device 110 is within range of a beacon from another vendor, the mobile application can be configured to be presented having a green color pallet. When a mobile computing device comes into range of a beacon from a first vendor, a notification of the nearby beacon can be presented on the screen of the mobile computing device as shown in FIG. 7B. When the user of the mobile computing device activates the mobile application, the mobile application can be presented on the screen of the mobile computing device having vendor-branded elements branded for the first vendor. When the mobile computing device comes into range of a beacon from a second vendor, the vendor-branded elements can be branded for the second vendor.

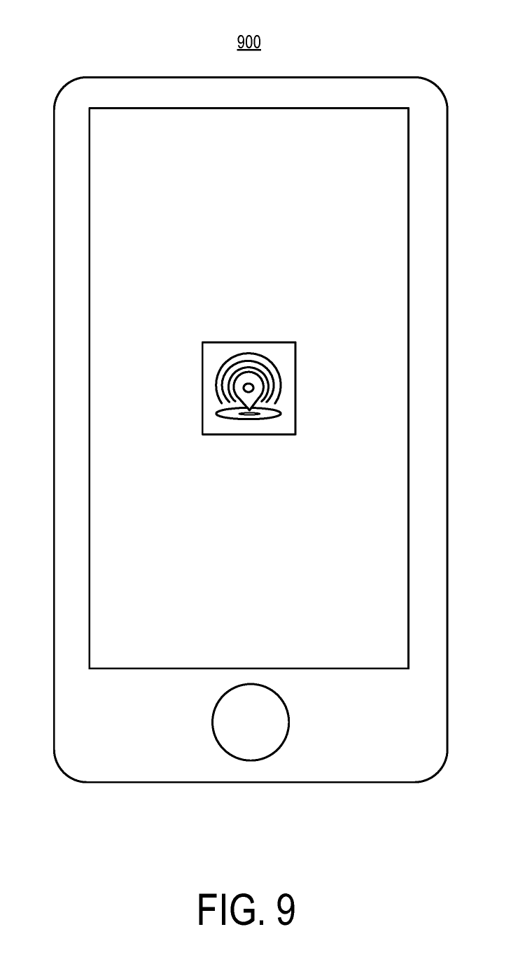

Differing amounts of customization of the mobile application executed on mobile computing devices 110 can be offered to vendors. Customization of the mobile application can offered at different levels. A more advanced level can offer additional vendor-branded elements than a less advanced level. Vendors can pay increasing amounts for the level of customization they desire to obtain. FIG. 9 is an illustration of a screenshot 900 providing a visualization of a loading screen for the mobile application. The loading screen for the mobile application can be customized for a vendor.

The mobile application provided to mobile computing device 110 can allow users to experience games through an interactive atmosphere, being incentivized by real world and digital world rewards given through the game. User can choose an alias, build up inventories, purchase tools, invest virtual currencies, achieve status rewards, and engage with the application in other ways traditional mobile games permit as well as custom additions to the game through partnerships and vendor demand. Tools can be unlocked, customized, branded, vendor specific, upgraded, and achieved.

Where a game is provided, such as shown in FIG. 6E, users who successfully win or complete a game can receive in-application virtual rewards. In-application virtual rewards can include medallions, coins, boxes, and/or other items. The in-application rewards can be collected and stored in the mobile application.

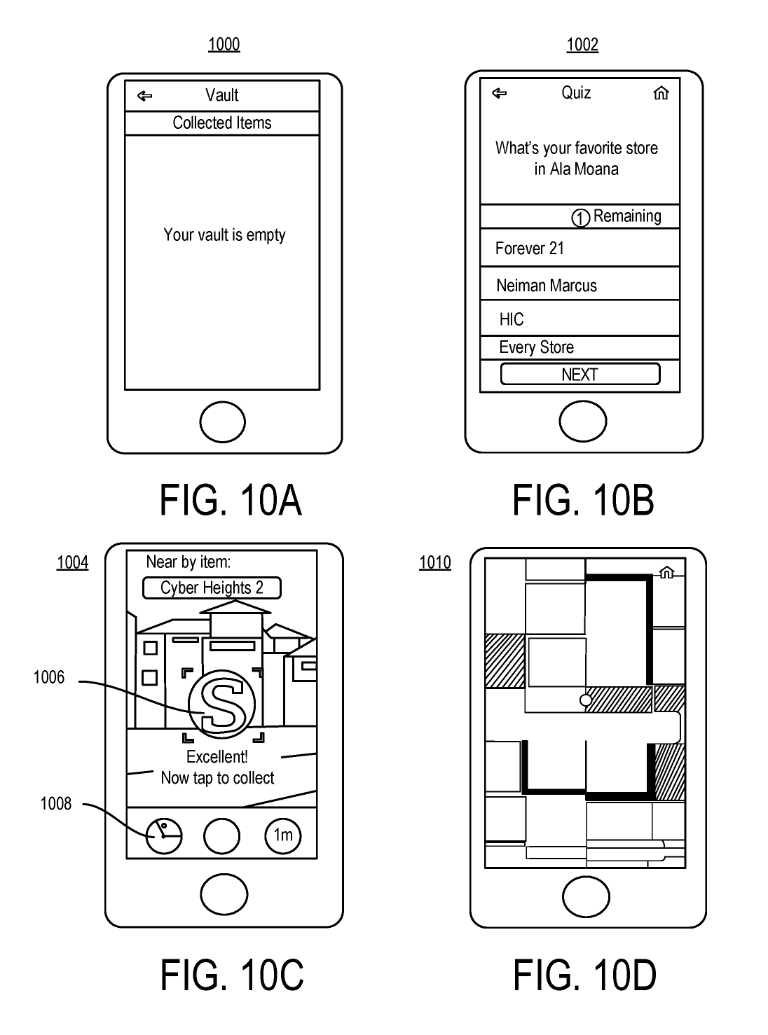

FIG. 10A is an illustration showing a screenshot 1000 of a visualization of a virtual vault in which the user's in-application virtual rewards can be stored. The in-application virtual items can be redeemed by using an in-application tool. Once the virtual item is collected, the database can determine its value and advertisement or real world reward that is presented to the mobile user. The mobile user can collect the virtual item and can be stored in their vault and can be accessible through the in-application control panel. The gaming mechanism by which the virtual items are collected cab depend upon the application of the platform specific to the vertical in which it is built for. The gaming mechanism can take different forms of animated sets of interactive tools (e.g. ray-gun, bow and arrow, boomerang, rocket gun, roll of toilet paper, retractable hand, etc.)

It will be appreciated that the virtual items as described herein can be used for a variety of applications and in a variety of settings. In one scenario, the virtual items can be uniform for all users, while in other scenarios, a profile (whether known or anonymously collected), can be used to provide customized virtual items. The virtual items will, in most cases, have at least one associated graphical user interface element that can be activated via the graphical user interface of the mobile computing device displaying the virtual item. Activating the graphical user interface element can cause another visualization to be displayed such as an offer/discount, a different virtual item, and the like. In addition, various types of portals can be provided to allow users to manage the distribution of virtual items and/or the offers/transactions provided in connection with same. In some cases, a platform provider may specify locations regarding various virtual items and, separately, various offer providers can either design and seed offers/transactions at such virtual item locations using such virtual items. In some cases, bidding engines and the like can be used to serve offers/transactions when there are competing vendors/offers.

An example of a gaming mechanic can be a quiz. The quiz can include questions specific to a particular location or event. FIG. 10B is an illustration of a screenshot 1002 that includes a quiz presented to the user of a mobile computing device on the screen of the mobile computing device. Another example of a gaming mechanic can include a scavenger hunt. The scavenger hunt can be based upon a specific event, such as an event centered around Memorial Day. FIG. 10C is an illustration of a screenshot 1004 that includes a quiz presented to the user of a mobile computing device on the screen of the mobile computing device. A user of the mobile computing device may be prompted to view the field of view of the camera. A virtual item 1006 can overlay the field of view of the camera when the mobile computing device gets within a range of a beacon and/or within a threshold distance from a geo-location. The user of the mobile computing device can touch the screen at the location of the virtual item 1006 and receive a virtual reward. A radar 1008 can be provided that provides an indication of the direction and distance to nearby beacons and/or geo-locations.

The elements of the game can be tailored to a vendor. This includes custom in-game elements branded with the vendor's logo as well as other items of their choosing. The vendor in this case can control the user's experience and through the WYSIWYG tool set and can place in-game elements. The vendor can also have the ability to set permissions and require certain criterion be met in-application before other elements are visible. For instance, users can be required to collect the vendor's element represented by their logo in a particular location before being allowed to continue onto the next destination, and so on. A custom set of tools can be provided to facilitate creation or establishment of the game for by the vendor. Event specific badges can be given to users that can only be achieved by playing the vendor's challenge. The end goal of such a challenge for the mobile user can be to gather beacon-specific or geo location-specific in-game elements, for example in the scavenger hunt format, in order to compete for the real world rewards given out by the event.

In some variations, users can be generally incentivized to gather in-application mobile elements (e.g., elements being specific types of content) through real world and virtual world rewards. Users can be exposed to advertisements at any geo-location (e.g., GPS coordinate, etc.) the vendor selects and can therefore confirm that user's close proximity to that location in real time.

In addition to content being pushed to a user via the field of vision view on his or her mobile computing device 110, a user can also actively search for particular types of content (using, for example, an input box concurrently displayed with the field of vision or alternatively as part of a separate view. For example, a user can search for a particular vendor's in-application mobile elements/content and where vendors physically have promotional opportunities (to allow, for example, the user to travel to such physical locations in order to redeem or otherwise acquire such content, etc.).

FIG. 10D is an illustration of a screenshot 1010 showing an animation that can be presented on the screen of a mobile computing device in response to a user completing an in-application game. The animation can be customized for a vendor.

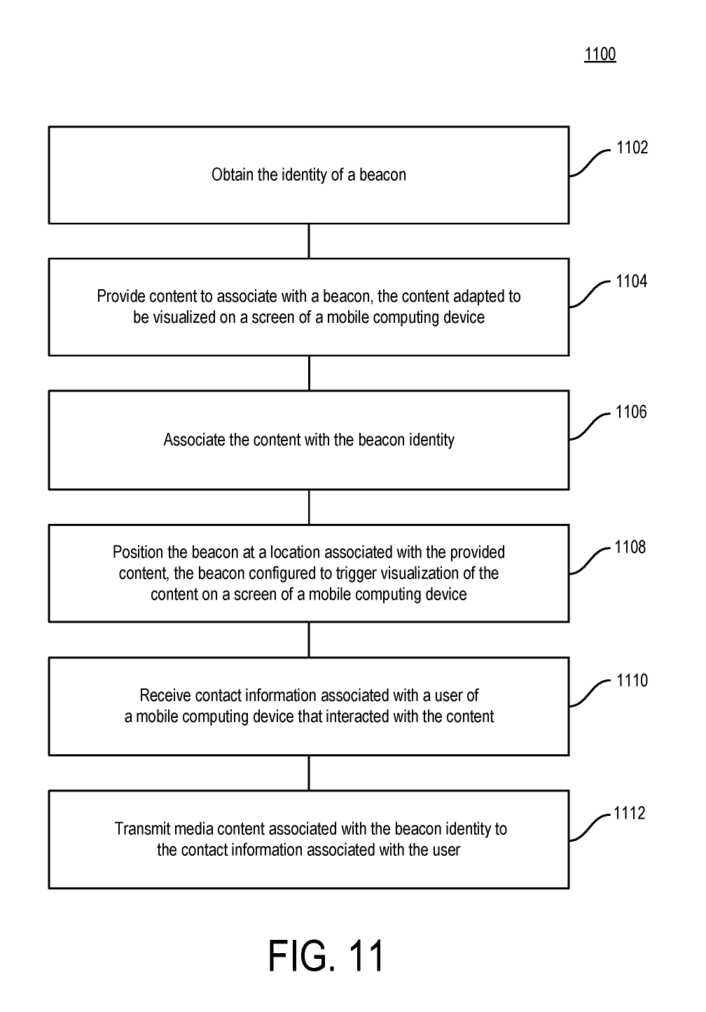

FIG. 11 is a process flow diagram 1100 illustrating a method for initiating a beacon. It will be appreciated that one or more of the aspects described with such workflow can be omitted depending on the desired implementation.

At 1102, an identity of a beacon can be obtained. The identity of the beacon can be a serial number of the beacon. The beacon can be configured to functions in accordance with a standard, or set of rules. The standard can dictate that each individual beacon is provided a unique identifier. At 1104, virtual content to associate with the beacon can be provided. For example, a vendor can provide virtual content as described in relation to FIGS. 2A-2F. The virtual content can be adapted to be visualized on a screen of a mobile computing device. At 1106, the content can be associated with the beacon identity. For example, the virtual content provided by a vendor can be linked to the unique identifier for the beacon, the virtual content linked to beacon can be provided to a mobile computing device when the mobile computing device is within range of the beacon.

At 1108, the beacon can be positioned at a location associated with the provided content. The beacon can be configured to trigger visualization of the content on a screen of a mobile computing device that comes within range of the beacon.

At 1110, contact information associated with a user of a mobile computing device that interacted with the content can be received. Contact information can include an IP address, an email address, a social media handle, and/or other contact information.

At 1112, media content associated with the beacon identity can be transmitted to the contact information associated with the user.

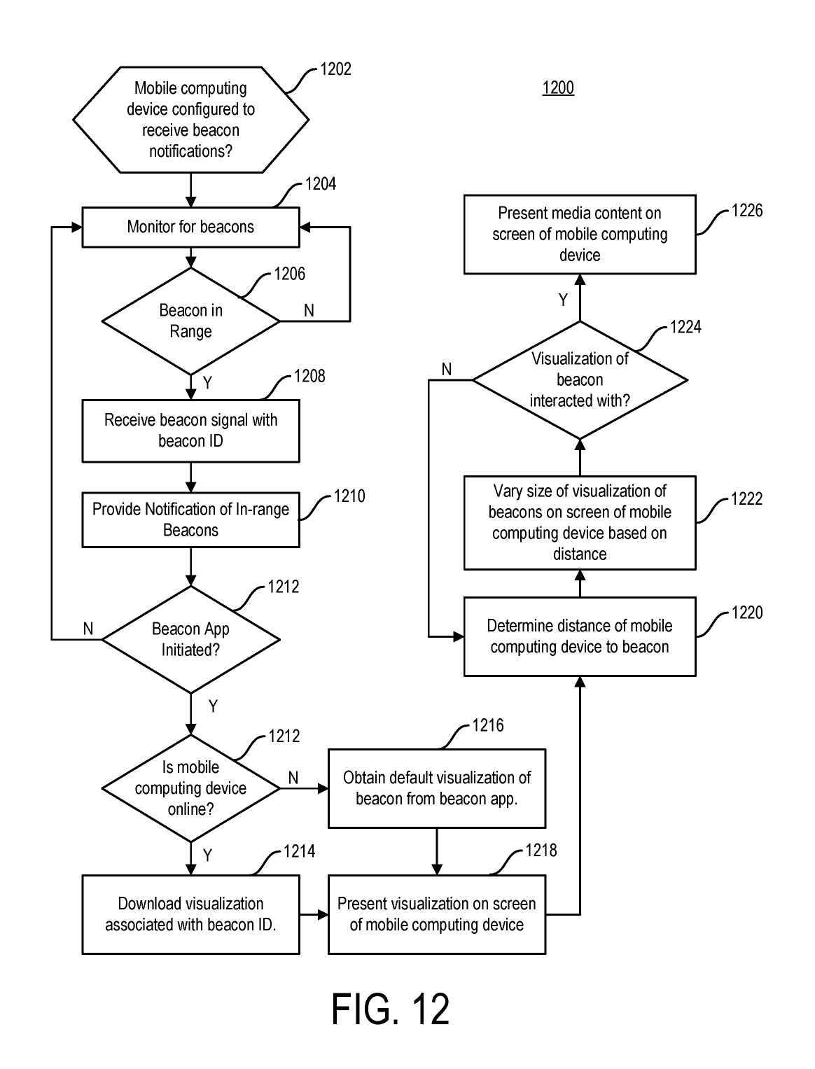

FIG. 12 is an illustration of a sample dataflow for presenting content on a mobile computing device, through a mobile application. It will be appreciated that one or more of the aspects described with such workflow can be omitted depending on the desired implementation. The user can download a resident client application on to the mobile computing device. This process can be initiated, for example, within an application download store such as ITUNES or GOOGLE PLAY, and the like, or alternatively it can be initiated via scanning a QR code.

At 1202, a determination can be made as to whether the mobile computing device is configured to receive beacon notifications. The mobile computing device can be a device that is capable of receiving beacon notifications, but has not been authorized to do so. A user can authorize the mobile computing device to receive beacon notifications, as described with relation to FIG. 7A. At 1204, the mobile computing device can be configured to monitor for beacons. The mobile computing device can passively monitor for beacons, such that the mobile computing device is configured to continually receive beacon signals and react to the receipt of the beacon signals. At 1206 a determination can be made as to whether the mobile computing device is within range of any beacons. The mobile computing device can continue monitoring for beacons if there are no beacons in range.

At 1208, in response to a beacon being in range, the identification of the beacon can be obtained. At 1210, a notification can be presented on the screen of the mobile computing device that the mobile computing device is within range of a beacon. The notification can be presented in the manner described with relation to FIG. 7B. At 1212 a determination can be made as to whether the mobile application associated with the beacon has been activated on the mobile computing device. A user of the mobile computing device can navigate to the application associated with the beacon and execute it in response to the notification that the mobile computing device is within range of a beacon at 1210.

At 1212 a determination can be made as to whether the mobile computing device is connected to the Internet. In response to determining that the mobile computing device is connected to the Internet at 1212, at 1214 a visualization associated with the beacon identification can be downloaded from the Internet. The visualization can be provided by a platform server, such as platform server 130 shown in FIG. 1, through one or more web servers, such as web servers 120 shown in FIG. 1. At 1216, in response to a determination that the mobile computing device is not connected to the Internet, a visualization of the beacon can be provided by the mobile application. The mobile application can include default visualizations for beacons, or past visualizations previously downloaded. When the visualization of the beacon is provided by the mobile application due to the mobile computing device being offline, the visualization can be amended to include a notification requesting that the user connects the mobile computing device to the Internet. At 1218, the visualization of the beacon can be presented on the screen of the mobile computing device. Such visualization can resemble that illustrated in FIGS. 4A-4E.

At 1220, a distance of the mobile computing device to the beacon can be determined. For example, the distance between the mobile computing device and the beacon can be determined based on a strength of the signal received at the mobile computing device from the beacon. At 1222, the size of the visualization of the beacon on the screen of the mobile computing device can be varied based on the distance of the mobile computing device to the beacon. For example, as described with respect to FIGS. 3, and 4A-4E. At 1224, a determination of whether the user has interacted with the visualization of the beacon can be determined. For example, the visualization of the beacon can be a virtual content item as illustrated in FIGS. 4A and 4B. A user of the mobile computing device can select, through, for example, a touch screen of the mobile computing device, one of the virtual content items representing a beacon. The mobile computing device can be configured to detect this interaction selecting the virtual content item.

In response to a determination that the visualization of the beacon has been interacted with, at 1226, media content can be presented on the screen of the mobile computing device. The media content can be provided to the mobile computing device through a web server(s). The media content can be obtained from electronic storage of the mobile computing device in the event that the mobile computing device is online. If the mobile computing device is offline and the electronic storage of the mobile computing device does not have the media content associated with the beacon, the mobile application can be configured to cause a notification to be displayed on the screen of the mobile computing device requesting that the user of the mobile computing device connect it to the Internet.

In some variations, the media content can be a mediated reality view displayed in a graphical user interface of the mobile computing device. For example, the mediated reality view of FIGS. 4C and 4D. The mediated reality view can be based on a relative spatial position of the mobile computing device and based on the monitored location of the mobile computing device relative to one or more beacons and/or geo-locations. The mediated view displays video captured by the at least one camera based on the position of the mobile computing device with the first virtual item overlaid on at least a portion of the displayed video. At least one of the size and shape of the first virtual item can vary depending on the location of monitored location of the mobile computing device relative to the geographical location associated with the first virtual item. User-generated input can be received that selects the virtual item overlaid on the field of view from the camera. A visualization can be provided in the graphical user interface in response to the user-generated input comprising at least one first graphical user interface element. User generated input can be received that activates one or more of the at least one first graphical user interface elements. At least one visualization can then be displayed in response to the user-generated input.

In a mediated reality view, a mediated reality smoothing algorithm can be implemented to optimize the stability of the nine axis sensor fusion equation and create a smooth mediated reality display. A mediated reality crowd handling algorithm can be implemented to control the amount and display of in-application elements on the mobile device. Advertisements/rewards can then be displayed on the mobile client based on the proximity to a beacon or a geo-location and/or based on a projected geo-location coordinates in a field of vision of the mobile client. The user can then click the visualized item. It can be determined whether the user is online. The offline mode is only allowed in certain game types, and is typically no the case. If the user is online then the user can be exposed (presented with) to the advertisements and/or rewards and collects item (e.g., the item is then associated with an account of the user, etc.). The advertisement/reward, in this case, can be removed from a corresponding database per the user location (i.e., the advertisement/reward is no longer visible to the user and/or to other users of the platform, etc.). If the user is offline, then the user can be exposed to the advertisement/reward or an identification corresponding to the advertisement/reward can be stored locally on the mobile client so that when the mobile client goes back online, the reward can be collected and removed from a corresponding database. Otherwise, the consolation is returned to the mobile client. The consolation in this case would be a virtual item that may or may not be associated with a real world reward in the event that the item has been removed from the database prior to the user getting back online to redeem the items.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in a computer program(s) that are executable and/or interpretable on a programmable system including at least one programmable processor, which may be special or general purpose, coupled to receive data and instructions from, and to transmit data and instructions to, a storage system, at least one input device, and at least one output device.

Without any way limiting the scope, interpretation, or application of the claims appearing below, a technical effect of one or more of the example embodiments disclosed herein is providing location-based offerings from vendors.

Without any way limiting the scope, interpretation, or application of the claims appearing below, a technical effect of one or more of the example embodiments disclosed herein is providing location-based offerings on mobile computing devices based on signals received by mobile computing devices from beacons positioned at locations associated with the subject matter of the offerings.

Without any way limiting the scope, interpretation, or application of the claims appearing below, a technical effect of one or more of the example embodiments disclosed herein is providing a visualization on a graphical user interface of a mobile computing device of an indication of the proximity of the mobile computing device to beacons and updating the visualization of the indication of the proximity of the mobile computing device to beacons in response to movement of the mobile computing device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claim.

What is claimed is:

1. A method executed by at least one data processor of a mobile computing device, the method comprising:
receiving at a mobile computing device a signal transmitted by a beacon, the signal indicating an identity of the beacon;
determining, at the mobile computing device, a distance between the beacon and the mobile computing device;
displaying in a graphical user interface of the mobile computing device, a virtual item associated with the beacon; and,
varying based on the determined distance, the size of the virtual item displayed in the graphical user interface.

2. The method as in claim 1, further comprising:
receiving a user-generated input through the mobile computing device activating the virtual item displayed on the screen of the mobile computing device; and,
providing a visualization on the screen of the mobile computing device in a graphical user interface, the visualization associated with the beacon.

3. The method as in claim 2, wherein the visualization includes a game, multimedia content, social media content, an advertisement, an offer, video content, graphical content, and/or informational content.

4. The method as in claim 2, wherein the visualization is configured to facilitate the collection of virtual points by a user of the mobile computing device.

5. The method as in claim 4, wherein the virtual points are redeemable for value from a vendor associated with the beacon.

6. The method as in claim 1, wherein the signal transmitted by the beacon is transmitted continuously.

7. The method as in claim 1, wherein the signal transmitted by the beacon is transmitted intermittently.

8. The method as in claim 1, wherein the signal transmitted by the beacon includes a time at which the signal was transmitted by the beacon.

9. The method as in claim 1, wherein the beacon is associated with a product.

10. The method as in claim 9, wherein the virtual item associated with the beacon resembles the product.

11. The method as in claim 1, further comprising:
displaying on a screen of the mobile computing device a notification indicating that a signal transmitted by a beacon has been received at the mobile computing device.

12. The method as in claim 1, further comprising:
displaying on a screen of a remote computing device electronically connected to the mobile computing device a notification indicating that a signal transmitted by a beacon has been received at the mobile computing device.

13. The method as in claim 1, wherein the distance between the beacon and the mobile computing device is based on a strength of the signal, transmitted by the beacon, as received at the mobile computing device.

14. The method as in claim as in claim 8, wherein the distance between the beacon and the mobile computing device is based on a time at which the signal, is received at the mobile computing device.

15. The method as in claim 1, further comprising:
receiving, at the mobile computing device, in response to receiving the signal transmitted by the beacon, the virtual item associated with the beacon from a web server.

16. The method as in claim 15, further comprising:
transmitting, by the mobile computing device, a request for the virtual item associated with the beacon through the one or more web servers.

17. The method as in claim 1, wherein the virtual item associated with the beacon is maintained by a platform server.

18. The method as in claim 1, further comprising:
receiving at the mobile computing device a second signal transmitted by a second beacon, the second signal indicating an identification information identity of the beacon;
determining, at the mobile computing device, a distance between the second beacon and the mobile computing device;
displaying in the graphical user interface of the mobile computing device, a second virtual item associated with the second beacon concomitantly with the virtual item associated with the beacon; and,
varying based on the determined distance between the second beacon and the mobile computing device, the size of the second virtual item displayed in the graphical user interface.

19. The method as in claim 1, wherein the mobile computing device comprises a camera and the graphical user interface of the mobile computing device displays a field of view captured by the camera.

20. The method as in claim 19, wherein the virtual item associated with the beacon is overlays the field of view captured by the camera and presented in the graphical user interface.

21. The method as in claim 1, further comprising:
receiving, at the mobile computing device, a geo-location signal;
determining, based on the geo-location signal, a geo-location of the mobile computing device;
receiving, at the mobile computing device, a virtual item associated with the geo-location of the mobile computing device; and,
presenting the virtual item in a graphical user interface on a screen of the mobile computing device.

22. A method executed by at least one data processor of a platform server, the method comprising:
receiving, at the platform server, the identity of a beacon configured to transmit a signal indicating an identity of the beacon;
receiving, at the platform server, virtual content, the virtual content configured for presenting in a graphical user interface of a screen of a mobile computing device configured to receive the signal transmitted by the beacon;
receiving, at the platform server, an indication that the mobile computing device has received the signal from the beacon; and,
transmitting, by the platform server, the virtual content to the mobile computing device for presentation in a graphical user interface on a screen of the mobile computing device.

23. The method as in claim 22, further comprising:
receiving, by the platform server, an indication that the virtual content presented in a graphical user interface of the mobile computing device has been interacted with by a user; and,
transmitting, by the platform server to the mobile computing device, additional virtual content associated with the beacon for presentation in the graphical user interface on the screen of the mobile computing device.

24. The method as in claim 22, further comprising:
receiving contact information associated with the mobile computing device.

25. The method as in claim 24, wherein the contact information includes a MAC address of the mobile computing device, an IP address of the mobile computing device, an email address of a user of the mobile computing device, and/or a telephone number of a user of the mobile computing device.

26. The method as in claim 24, further comprising:
transmitting, by the platform server, the contact information to an operator of the beacon.

27. The method as in claim 22, wherein the beacon is located with a product.

28. The method as in claim 27, wherein the virtual content associated with the beacon is associated with the product.

29. The method as in claim 23, further comprising:
providing, through the mobile computing device, an offer to the user of the mobile computing device.

30. An apparatus comprising:
at least one processor circuitry; and,
at least one memory circuitry including computer program code which when by the at least one processor circuitry causes at least the following:
receive, at a mobile computing device a signal transmitted by a beacon, the signal indicating an identity of the beacon;
determine, at the mobile computing device, a distance between the beacon and the mobile computing device;
display in a graphical user interface of the mobile computing device, a virtual item associated with the beacon; and,
vary, based on the determined distance, the size of the virtual item displayed in the graphical user interface.

31. The apparatus as in claim 30, wherein the computer program code is further configured to cause at least the following:
receive a user-generated input through the mobile computing device activating the virtual item displayed on the screen of the mobile computing device; and,
provide a visualization on the screen of the mobile computing device in a graphical user interface, the visualization associated with the beacon.

32. The apparatus as in claim 31, wherein the visualization includes a game, multimedia content, social media content, an advertisement, an offer, video content, graphical content, and/or informational content.

33. The apparatus as in claim 31, wherein the visualization is configured to facilitate the collection of virtual points by a user of the mobile computing device.

34. The apparatus as in claim 33, wherein the virtual points are redeemable for value from a vendor associated with the beacon.

35. The apparatus as in claim 30, wherein the signal transmitted by the beacon is transmitted continuously.

36. The apparatus as in claim 30, wherein the signal transmitted by the beacon is transmitted intermittently.

37. The apparatus as in claim 30, wherein the signal transmitted by the beacon includes a time at which the signal was transmitted by the beacon.

38. The apparatus as in claim 30, wherein the beacon is associated with a product.

39. The apparatus as in claim 38, wherein the virtual item associated with the beacon resembles the product.

40. The apparatus as in claim 30, wherein the computer program code is further configured to cause at least the following:
display on a screen of the mobile computing device a notification indicating that a signal transmitted by a beacon has been received at the mobile computing device.

41. The apparatus as in claim 30, wherein the computer program code is further configured to cause at least the following:
display on a screen of a remote computing device electronically connected to the mobile computing device a notification indicating that a signal transmitted by a beacon has been received at the mobile computing device.

42. The apparatus as in claim 30, wherein the distance between the beacon and the mobile computing device is based on a strength of the signal, transmitted by the beacon, as received at the mobile computing device.

43. The apparatus as in claim as in claim 37, wherein the distance between the beacon and the mobile computing device is based on a time at which the signal, is received at the mobile computing device.

44. The apparatus as in claim 30, wherein the computer program code is further configured to cause at least the following:
receive, at the mobile computing device, in response to receiving the signal transmitted by the beacon, the virtual item associated with the beacon from a web server.

45. The apparatus as in claim 44, wherein the computer program code is further configured to cause at least the following:
transmit, by the mobile computing device, a request for the virtual item associated with the beacon through the one or more web servers.

46. The apparatus as in claim 30, wherein the virtual item associated with the beacon is maintained by a platform server.

47. The apparatus as in claim 30, wherein the computer program code is further configured to cause at least the following:
receive at the mobile computing device a second signal transmitted by a second beacon, the second signal indicating an identification information identity of the beacon;
determine, at the mobile computing device, a distance between the second beacon and the mobile computing device;
display in the graphical user interface of the mobile computing device, a second virtual item associated with the second beacon concomitantly with the virtual item associated with the beacon; and,
vary based on the determined distance between the second beacon and the mobile computing device, the size of the second virtual item displayed in the graphical user interface.

48. The apparatus as in claim 30, wherein the mobile computing device comprises a camera and the graphical user interface of the mobile computing device displays a field of view captured by the camera.

49. The apparatus as in claim 48, wherein the virtual item associated with the beacon is overlays the field of view captured by the camera and presented in the graphical user interface.

50. The apparatus as in claim 30, wherein the computer program code is further configured to cause at least the following:
receive, at the mobile computing device, a geo-location signal;
determine, based on the geo-location signal, a geo-location of the mobile computing device;
receive, at the mobile computing device, a virtual item associated with the geo-location of the mobile computing device; and,
present the virtual item in a graphical user interface on a screen of the mobile computing device.

51. An apparatus comprising:
at least one processor circuitry; and,
at least one memory circuitry including computer program code which when by the at least one processor circuitry causes at least the following:
receive, at a platform server, the identity of a beacon configured to transmit a signal indicating an identity of the beacon;
receive, at the platform server, virtual content, the virtual content configured for presenting in a graphical user interface of a screen of a mobile computing device configured to receive the signal transmitted by the beacon;
receive, at the platform server, an indication that the mobile computing device has received the signal from the beacon; and,
transmit, by the platform server, the virtual content to the mobile computing device for presentation in a graphical user interface on a screen of the mobile computing device.

52. The apparatus as in claim 51, wherein the computer program code is further configured to cause at least the following:
receive, by the platform server, an indication that the virtual content presented in a graphical user interface of the mobile computing device has been interacted with by a user; and,
transmit, by the platform server to the mobile computing device, additional virtual content associated with the beacon for presentation in the graphical user interface on the screen of the mobile computing device.

53. The apparatus as in claim 52, wherein the computer program code is further configured to cause at least the following:
receive contact information associated with the mobile computing device.

54. The apparatus as in claim 53, wherein the contact information includes a MAC address of the mobile computing device, an IP address of the mobile computing device, an email address of a user of the mobile computing device, and/or a telephone number of a user of the mobile computing device.

55. The apparatus as in claim 53, wherein the computer program code is further configured to cause at least the following:
transmit, by the platform server, the contact information to an operator of the beacon.

56. The apparatus as in claim 51, wherein the beacon is located with a product.

57. The apparatus as in claim 56, wherein the virtual content associated with the beacon is associated with the product.

58. The apparatus as in claim 51, wherein the computer program code is further configured to cause at least the following:
provide, through the mobile computing device, an offer to the user of the mobile computing device.
